(19) United States
(12) Patent Application Publication
(10) Pub. No.: US 2025/0103618 A1
(43) Pub. Date: Mar. 27, 2025

(54) PARENTAL COMMUNITIES CLASSIFICATION

(71) Applicant: Ancestry.com DNA, LLC, Lehi, UT (US)

(72) Inventors: Milos Pavlovic, Sandy, UT (US); Ross Eugene Curtis, Cedar Hills, UT (US); Ameen Eetemadi, San Francisco, CA (US); Clinton C. Mason, Bountiful, UT (US)

(21) Appl. No.: 18/895,799

(22) Filed: Sep. 25, 2024

Related U.S. Application Data
(60) Provisional application No. 63/540,306, filed on Sep. 25, 2023.

(51) Int. Cl. G06F 16/28; G06F 16/22; G06N 20/20

(52) U.S. Cl. CPC G06F 16/287; G06F 16/2246; G06F 16/288; G06N 20/20

(57) ABSTRACT

Disclosed are methods for predicting assignments of users to groups based on obtained data. The methods may include phasing the obtained data of a user and inputting features of the phased data to a trained model to receive an output that provides information associated with a group assignment of the user. The model may be trained with a plurality of training samples, each training sample comprising features of phased user data of a reference user and a label identifying whether the reference user belongs to a group. Training the model may include applying a plurality of classifiers to at least one of the training samples to obtain an output from each classifier, determining an average of the outputs from applying the plurality of classifiers, and determining the average of the plurality of classifiers as the output from the model.

### CROSS-REFERENCE TO RELATED APPLICATIONS

This application claims the benefit of U.S. Provisional Application No. 63/540,306, filed Sep. 25, 2023, which is incorporated by reference herein in its entirety.

### FIELD

The disclosed embodiments relate to classification, particularly, to classification using user data.

### BACKGROUND

A large-scale database can include billions of data records. This type of database may allow users to build connections, research history, and make meaningful discoveries about past events. Users may try to identify related records within the database. However, identifying connections in the sheer amount of data is not a trivial task. Datasets associated with different users may not be connected without a proper determination of how the datasets are related. Comparing a large number of datasets without a concrete strategy may also be computationally infeasible because each dataset may also include a large number of data bits. Given a user dataset and a database with datasets that are potentially related to the user dataset, it is often challenging to identify a dataset in the database that is associated with the user dataset.

Current group assignment methods are trained using inheritance data. When applying current group assignment methods to inheritance data, such as when using a phased portion of a dataset, users may experience a significant change in group assignment, and this could be an undesirable result in terms of user experience. As such, optimization is needed to minimize the change in assignments from unphased inheritance data to phased inheritance data.

### SUMMARY

Disclosed herein relates to example embodiments for predicting assignments of named entities to communities based on obtained inheritance data. The method may include phasing the obtained inheritance data of a named entity and inputting a selected subset of the phased data to a trained model to receive an output that provides information associated with a community assignment of the named entity. The model may be trained with a plurality of training samples, each training sample comprising a selected dataset of phased user data of a reference named entity and a label identifying whether the reference named entity belongs to a community. Training the model may include applying a plurality of classifiers to at least one of the training samples to obtain an output from each classifier, determining an average of the outputs from the plurality of classifiers, and determining the average as the output from the model.

In yet another embodiment, a non-transitory computer-readable medium that is configured to store instructions is described. The instructions, when executed by one or more processors, cause the one or more processors to perform a process that includes steps described in the above computer-implemented methods or described in any embodiments of this disclosure. In yet another embodiment, a system may include one or more processors and a storage medium that is configured to store instructions. The instructions, when executed by one or more processors, cause the one or more processors to perform a process that includes steps described in the above computer-implemented methods or described in any embodiments of this disclosure.

### BRIEF DESCRIPTION OF THE DRAWINGS

FIG. 1 illustrates a diagram of a system environment of an example computing system, in accordance with some embodiments.

FIG. 2 is a block diagram of an architecture of an example computing system, in accordance with some embodiments.

FIG. 3 is a flowchart illustrating a method of using a model to predict if an individual is a member of a community, in accordance with some embodiments.

FIG. 4A is a flowchart depicting an example process for training a haploid community assignment ML model, in accordance with some embodiments.

FIG. 4B illustrates an example process for training a haploid community assignment ML model, in accordance with some embodiments.

FIG. 5A illustrates a selection of a feature vector using haplotypes associated with both parents of an individual, in accordance with some embodiments.

FIG. 5B is a conceptual diagram graphically illustrating a training stage in the haploid community assignment ML model, in accordance with some embodiments.

FIG. 5C is a conceptual diagram graphically illustrating another training stage in the haploid community assignment ML model, in accordance with some embodiments.

FIG. 5D is a conceptual diagram graphically illustrating another training stage in the haploid community assignment ML model, in accordance with some embodiments.

FIG. 5E is a conceptual diagram graphically illustrating another training stage in the haploid community assignment ML model, in accordance with some embodiments.

FIG. 5F is a conceptual diagram graphically illustrating another training stage in the haploid community assignment ML model, in accordance with some embodiments.

FIG. 6 illustrates a structure of an example neural network, in accordance with some embodiments.

FIG. 7 is a block diagram of an example computing device, in accordance with some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The figures (FIGs.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Disclosed are techniques for predicting assignments of individuals to communities based on haploid data. Using a phasing algorithm that provides long-range and cross-chromosome accuracy, a target individual's genotype data may be phased into a pair of haplotypes with a high confidence that each haplotype belongs to a parent of the target individual. Using each haplotype, the inheritance communities to which the haplotypes belong may be assigned using a machine learning model. Features may be extracted from the haplotypes of the target individual to form a feature vector, such as by comparing a haplotype to a reference panel of a community. The feature vector is input into the machine learning model to predict whether the haplotype should be assigned to a particular inheritance community. The process may be repeated for the second haplotype phased from the genotype of the target individual. The techniques used in this disclosure may further include, in some embodiments, using Least Absolute Shrinkage and Selection Operator (“Lasso”) logistics regression in selecting features, using only one haplotype with higher confidence in assignment for training the new machine learning models, and using Bagging in training classifiers. In this way, the disclosed techniques reduce the changes in assignments from using diploid data to haploid data. The disclosed techniques improve the accuracy in assignment of individuals to communities. For example, in the case of French American communities, the disclosed methods facilitate 95% parental community assignment, including detecting a single parent origin for 85% of users.

### Example System Environment

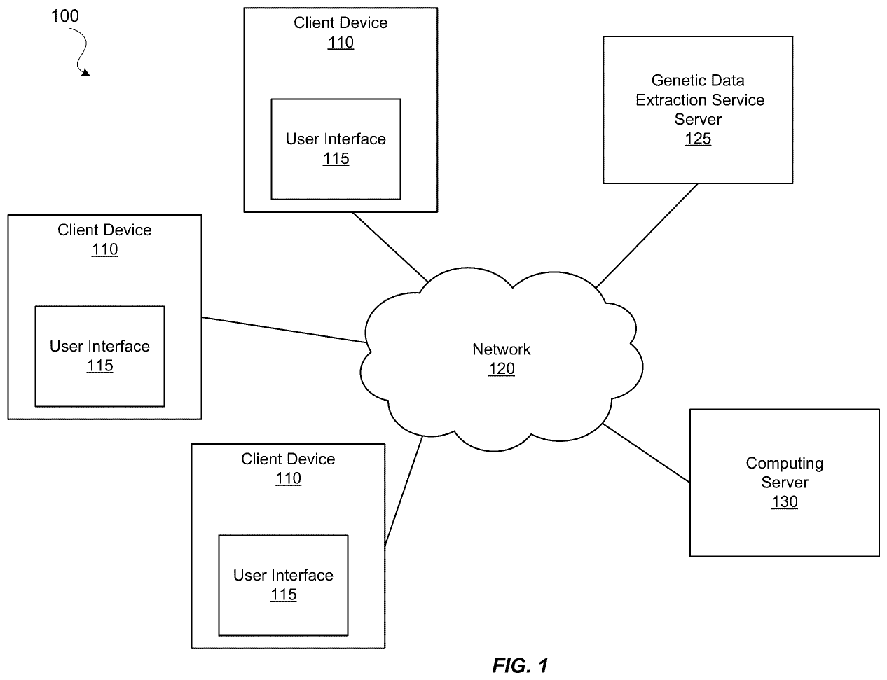

FIG. 1 illustrates a diagram of a system environment 100 of an example computing server 130, in accordance with some embodiments. The system environment 100 shown in FIG. 1 includes one or more client devices 110, a network 120, a genetic data extraction service server 125, and a computing server 130. In various embodiments, the system environment 100 may include fewer or additional components. The system environment 100 may also include different components.

The client devices 110 are one or more computing devices capable of receiving user input as well as transmitting and/or receiving data via a network 120. Example computing devices include desktop computers, laptop computers, personal digital assistants (PDAs), smartphones, tablets, wearable electronic devices (e.g., smartwatches), smart household appliances (e.g., smart televisions, smart speakers, smart home hubs), Internet of Things (IoT) devices or other suitable electronic devices. A client device 110 communicates to other components via the network 120. Users may be customers of the computing server 130 or any individuals who access the system of the computing server 130, such as an online website or a mobile application. In some embodiments, a client device 110 executes an application that launches a graphical user interface (GUI) for a user of the client device 110 to interact with the computing server 130. The GUI may be an example of a user interface 115. A client device 110 may also execute a web browser application to enable interactions between the client device 110 and the computing server 130 via the network 120. In another embodiment, the user interface 115 may take the form of a software application published by the computing server 130 and installed on the user device 110. In yet another embodiment, a client device 110 interacts with the computing server 130 through an application programming interface (API) running on a native operating system of the client device 110, such as IOS or ANDROID.

The network 120 provides connections to the components of the system environment 100 through one or more sub-networks, which may include any combination of local area and/or wide area networks, using both wired and/or wireless communication systems. In some embodiments, a network 120 uses standard communications technologies and/or protocols. For example, a network 120 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 120 may be represented using any suitable format, such as hypertext markup language (HTML) or extensible markup language (XML). In some embodiments, all or some of the communication links of a network 120 may be encrypted using any suitable technique or techniques such as secure sockets layer (SSL), transport layer security (TLS), virtual private networks (VPNs), Internet Protocol security (IPsec), etc. The network 120 also includes links and packet-switching networks such as the Internet.

Individuals, who may be customers of a company operating the computing server 130, provide biological samples for analysis of their genetic data. Individuals may also be referred to as users. In some embodiments, an individual uses a sample collection kit to provide a biological sample (e.g., saliva, blood, hair, tissue) from which genetic data is extracted and determined according to nucleotide processing techniques such as microarray, amplification and/or sequencing. Microarray may include immobilizing probe DNA sequences, onto a solid surface such as a glass slide. Target DNA samples, labeled with fluorescent tags, are then applied to the microarray surface. Through complementary base pairing, the labeled DNA binds to its corresponding probe on the microarray. By detecting the fluorescence emitted by the labeled DNA, genetic data may be extracted. Amplification may include using polymerase chain reaction (PCR) to amplify segments of nucleotide samples. Sequencing may include sequencing of deoxyribonucleic acid (DNA) sequencing, ribonucleic acid (RNA) sequencing, etc. Suitable sequencing techniques may include Sanger sequencing and massively parallel sequencing such as various next-generation sequencing (NGS) techniques including whole genome sequencing, pyrosequencing, sequencing by synthesis, sequencing by ligation, and ion semiconductor sequencing. In some embodiments, a set of SNPs (e.g., 300,000) that are shared between different array platforms (e.g., Illumina OmniExpress Platform and Illumina HumanHap 650Y Platform) may be obtained as genetic data. Genetic data extraction service server 125 receives biological samples from users of the computing server 130. The genetic data extraction service server 125 extracts genetic data from the samples and the data may take the form of a set of SNPs. The genetic data extraction service server 125 generates the genetic data of the individuals based on sequencing or microarray results. The genetic data may include data generated from DNA or RNA and may include base pairs from coding and/or noncoding regions of DNA.

The genetic data may take different forms and include information regarding various biomarkers of an individual. For example, in some embodiments, the genetic data may be the base pair sequence of an individual. The base pair sequence may include the whole genome or a part of the genome such as certain genetic loci of interest. In another embodiment, the genetic data extraction service server 125 may determine genotypes from DNA identification results, for example by identifying genotype values of single nucleotide polymorphisms (SNPs) present within the DNA. The results in this example may include a sequence of genotypes corresponding to various SNP sites. A SNP site may also be referred to as a SNP loci. A genetic locus is a segment of a genetic sequence. A locus can be a single site or a longer stretch. The segment can be a single base long or multiple bases long. In some embodiments, the genetic data extraction service server 125 may perform data pre-processing of the genetic data to convert raw sequences of base pairs to sequences of genotypes at target SNP sites. Since a typical human genome may differ from a reference human genome at only several million SNP sites (as opposed to billions of base pairs in the whole genome), the genetic data extraction service server 125 may extract only the genotypes at a set of target SNP sites and transmit the extracted data to the computing server 130 as the inheritance dataset of an individual. SNPs, base pair sequences, genotypes, haplotypes, RNA sequences, protein sequences, and phenotypes are examples of biomarkers. In some embodiments, each SNP site may have two readings that are heterozygous.

The computing server 130 performs various analyses of the genetic data, genealogy data, and users' survey responses to generate results regarding the phenotypes and genealogy of users of computing server 130. Depending on the embodiments, the computing server 130 may also be referred to as an online server, a personal genetic service server, a genealogy server, a family tree building server, and/or a social networking system. The computing server 130 receives genetic data from the genetic data extraction service server 125 and stores the genetic data in the data store of the computing server 130. The computing server 130 may analyze the data to generate results regarding the genetics or genealogy of users. The results regarding the genetics or genealogy of users may include the ethnicity compositions of users, paternal and maternal genetic analysis, identification or suggestion of potential family relatives, ancestor information, analyses of DNA data, potential or identified traits such as phenotypes of users (e.g., diseases, appearance traits, other genetic characteristics, and other non-genetic characteristics including social characteristics), etc. The computing server 130 may present or cause the user interface 115 to present the results to the users through a GUI displayed on the client device 110. The results may include graphical elements, textual information, data, charts, and other elements such as family trees.

In some embodiments, the computing server 130 also allows various users to create one or more genealogical profiles of the user. The genealogical profile may include a list of individuals (e.g., ancestors, relatives, friends, and other people of interest) who are added or selected by the user or suggested by the computing server 130 based on the genealogical records and/or genetic records. The user interface 115 controlled by or in communication with the computing server 130 may display the individuals in a list or as a family tree such as in the form of a pedigree chart. In some embodiments, subject to the user's privacy setting and authorization, the computing server 130 may allow information generated from the user's inheritance dataset to be linked to the user profile and to one or more of the family trees. The users may also authorize the computing server 130 to analyze their inheritance dataset and allow their profiles to be discovered by other users.

### Example Computing Server Architecture

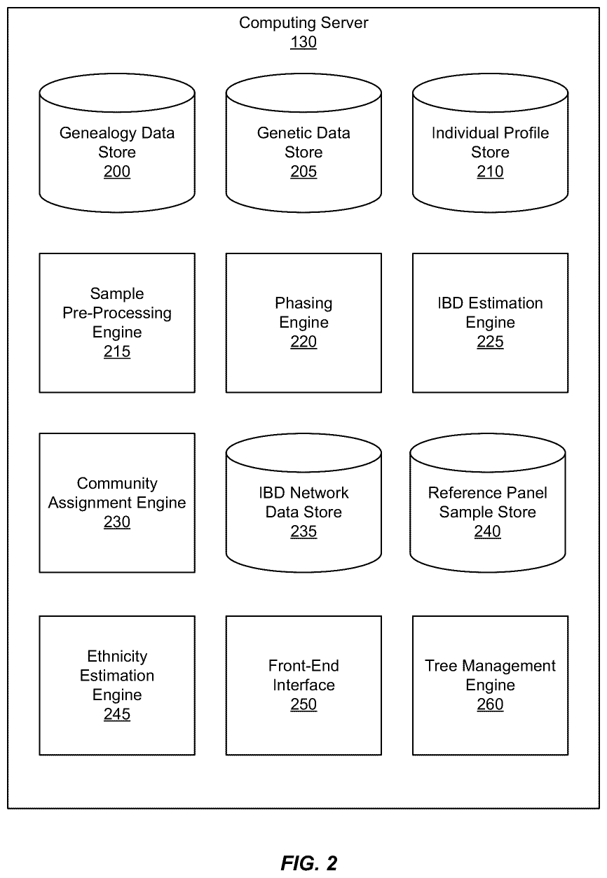

FIG. 2 is a block diagram of the architecture of an example computing server 130, in accordance with some embodiments. In the embodiment shown in FIG. 2, the computing server 130 includes a genealogy data store 200, a genetic data store 205, an individual profile store 210, a sample pre-processing engine 215, a phasing engine 220, an identity by descent (IBD) estimation engine 225, a community assignment engine 230, an IBD network data store 235, a reference panel sample store 240, an ethnicity estimation engine 245, a front-end interface 260, and a tree management engine 250. The functions of the computing server 130 may be distributed among the elements in a different manner than described. In various embodiments, the computing server 130 may include different components and fewer or additional components. Each of the various data stores may be a single storage device, a server controlling multiple storage devices, or a distributed network that is accessible through multiple nodes (e.g., a cloud storage system).

The computing server 130 stores various data of different individuals, including genetic data, genealogy data, and survey response data. The computing server 130 processes the genetic data of users to identify shared identity-by-descent (IBD) segments between individuals. The genealogy data and survey response data may be part of user profile data. The amount and type of user profile data stored for each user may vary based on the information of a user, which is provided by the user as she creates an account and profile at a system operated by the computing server 130 and continues to build her profile, family tree, and social network at the system and to link her profile with her genetic data. Users may provide data via the user interface 115 of a client device 110. Initially and as a user continues to build her genealogical profile, the user may be prompted to answer questions related to the basic information of the user (e.g., name, date of birth, birthplace, etc.) and later on more advanced questions that may be useful for obtaining additional genealogy data. The computing server 130 may also include survey questions regarding various traits of the users such as the users' phenotypes, characteristics, preferences, habits, lifestyle, environment, etc.

Genealogy data may be stored in the genealogy data store 200 and may include various types of data that are related to tracing family relatives of users. Examples of genealogy data include names (first, last, middle, suffixes), gender, birth locations, date of birth, date of death, marriage information, spouse's information kinships, family history, dates and places for life events (e.g., birth and death), other vital data, and the like. In some instances, family history can take the form of a pedigree of an individual (e.g., the recorded relationships in the family). The family tree information associated with an individual may include one or more specified nodes. Each node in the family tree represents the individual, an ancestor of the individual who might have passed down genetic material to the individual, and the individual's other relatives including siblings, cousins, and offspring in some cases. Genealogy data may also include connections and relationships among users of the computing server 130. The information related to the connections between a user and her relatives that may be associated with a family tree may also be referred to as pedigree data or family tree data.

In addition to user-input data, genealogy data may also take other forms that are obtained from various sources such as public records and third-party data collectors. For example, genealogical records from public sources include birth records, marriage records, death records, census records, court records, probate records, adoption records, obituary records, etc. Likewise, genealogy data may include data from one or more family trees of an individual, the Ancestry World Tree system, a Social Security Death Index database, the World Family Tree system, a birth certificate database, a death certificate database, a marriage certificate database, an adoption database, a draft registration database, a veterans database, a military database, a property records database, a census database, a voter registration database, a phone database, an address database, a newspaper database, an immigration database, a family history records database, a local history records database, a business registration database, a motor vehicle database, and the like.

Furthermore, the genealogy data store 200 may also include relationship information inferred from the genetic data stored in the genetic data store 205 and information received from the individuals. For example, the relationship information may indicate which individuals are genetically related, how they are related, how many generations back they share common ancestors, lengths and locations of IBD segments shared, which genetic communities an individual is a part of, variants carried by the individual, and the like.

The computing server 130 maintains inheritance datasets of individuals in the genetic data store 205. An inheritance dataset of an individual may be a digital dataset of nucleotide data (e.g., SNP data) and corresponding metadata. For example, an inheritance dataset may be genetic data extracted by the genetic data extraction service server 125. An inheritance dataset may contain data on the whole or portions of an individual's genome. The genetic data store 205 may store a pointer to a location associated with the genealogy data store 200 associated with the individual. An inheritance dataset may take different forms. In some embodiments, an inheritance dataset may take the form of a base pair sequence of the sequencing result of an individual. A base pair sequence dataset may include the whole genome of the individual (e.g., obtained from a whole-genome sequencing) or some parts of the genome (e.g., genetic loci of interest). A microarray data may take the form of SNP data at target positions in the genome.

In another embodiment, an inheritance dataset may take the form of sequences of genetic markers. Examples of genetic markers may include target SNP sites (e.g., allele sites) filtered from the DNA identification results. A SNP site that is a single base pair long may also be referred to as a SNP locus. A SNP site may be associated with a unique identifier. The inheritance dataset may be in the form of diploid data that includes a sequence of genotypes, such as genotypes at the target SNP site, or the whole base pair sequence that includes genotypes at known SNP sites and other base pair sites that are not commonly associated with known SNPs. The diploid dataset may be referred to as a genotype dataset or a genotype sequence. Genotype may have a different meaning in various contexts. In one context, an individual's genotype may refer to a collection of diploid alleles of an individual. In other contexts, a genotype may be a pair of alleles present on two chromosomes for an individual at a given genetic marker such as a SNP site.

Genotype data for a SNP site may include a pair of alleles. The pair of alleles may be homozygous (e.g., A-A or G-G) or heterozygous (e.g., A-T, C-T). Instead of storing the actual nucleotides, the genetic data store 205 may store genetic data that are converted to bits. For a given SNP site, oftentimes only two nucleotide alleles (instead of all 4) are observed. As such, a 2-bit number may represent a SNP site. For example, 00 may represent homozygous first alleles, 11 may represent homozygous second alleles, and 01 or 10 may represent heterozygous alleles. A separate library may store what nucleotide corresponds to the first allele and what nucleotide corresponds to the second allele at a given SNP site.

A diploid dataset may also be phased into two sets of haploid data, one corresponding to a first parent side and another corresponding to a second parent side. The phased datasets may be referred to as haplotype datasets or haplotype sequences. Similar to genotype, haplotype may have a different meaning in various contexts. In one context, a haplotype may also refer to a collection of alleles that corresponds to a genetic segment. In other contexts, a haplotype may refer to a specific allele at a SNP site. For example, a sequence of haplotypes may refer to a sequence of alleles of an individual that are inherited from a parent.

The individual profile store 210 stores profiles and related metadata associated with various individuals appeared in the computing server 130. A computing server 130 may use unique individual identifiers to identify various users and other non-users that might appear in other data sources such as ancestors or historical persons who appear in any family tree or genealogy database. A unique individual identifier may be a hash of certain identification information of an individual, such as a user's account name, user's name, date of birth, location of birth, or any suitable combination of the information. The profile data related to an individual may be stored as metadata associated with an individual's profile. For example, the unique individual identifier and the metadata may be stored as a key-value pair using the unique individual identifier as a key.

An individual's profile data may include various kinds of information related to the individual. The metadata about the individual may include one or more pointers associating inheritance datasets such as genotype and phased haplotype data of the individual that are saved in the genetic data store 205. The metadata about the individual may also be individual information related to family trees and pedigree datasets that include the individual. The profile data may further include declarative information about the user that was authorized by the user to be shared and may also include information inferred by the computing server 130. Other examples of information stored in a user profile may include biographic, demographic, and other types of descriptive information such as work experience, educational history, gender, hobbies, preferences, location and the like. In some embodiments, the user profile data may also include one or more photos of the users and photos of relatives (e.g., ancestors) of the users that are uploaded by the users. A user may authorize the computing server 130 to analyze one or more photos to extract information, such as the user's or relative's appearance traits (e.g., blue eyes, curved hair, etc.), from the photos. The appearance traits and other information extracted from the photos may also be saved in the profile store. In some cases, the computing server may allow users to upload many different photos of the users, their relatives, and even friends. User profile data may also be obtained from other suitable sources, including historical records (e.g., records related to an ancestor), medical records, military records, photographs, other records indicating one or more traits, and other suitable recorded data.

For example, the computing server 130 may present various survey questions to its users from time to time. The responses to the survey questions may be stored at individual profile store 210. The survey questions may be related to various aspects of the users and the users' families. Some survey questions may be related to users' phenotypes, while other questions may be related to the environmental factors of the users.

Survey questions may concern health or disease-related phenotypes, such as questions related to the presence or absence of genetic diseases or disorders, inheritable diseases or disorders, or other common diseases or disorders that have a family history as one of the risk factors, questions regarding any diagnosis of increased risk of any diseases or disorders, and questions concerning wellness-related issues such as a family history of obesity, family history of causes of death, etc. The diseases identified by the survey questions may be related to single-gene diseases or disorders that are caused by a single-nucleotide variant, an insertion, or a deletion. The diseases identified by the survey questions may also be multifactorial inheritance disorders that may be caused by a combination of environmental factors and genes. Examples of multifactorial inheritance disorders may include heart disease, Alzheimer's disease, diabetes, cancer, and obesity. The computing server 130 may obtain data on a user's disease-related phenotypes from survey questions about the health history of the user and her family and also from health records uploaded by the user.

Survey questions also may be related to other types of phenotypes such as appearance traits of the users. A survey regarding appearance traits and characteristics may include questions related to eye color, iris pattern, freckles, chin types, finger length, dimple chin, earlobe types, hair color, hair curl, skin pigmentation, susceptibility to skin burn, bitter taste, male baldness, baldness pattern, presence of unibrow, presence of wisdom teeth, height, and weight. A survey regarding other traits also may include questions related to users' taste and smell such as the ability to taste bitterness, asparagus smell, cilantro aversion, etc. A survey regarding traits may further include questions related to users' body conditions such as lactose tolerance, caffeine consumption, malaria resistance, norovirus resistance, muscle performance, alcohol flush, etc. Other survey questions regarding a person's physiological or psychological traits may include vitamin traits and sensory traits such as the ability to sense an asparagus metabolite. Traits may also be collected from historical records, electronic health records and electronic medical records.

The computing server 130 also may present various survey questions related to the environmental factors of users. In this context, an environmental factor may be a factor that is not directly connected to the genetics of the users. Environmental factors may include users' preferences, habits, and lifestyles. For example, a survey regarding users' preferences may include questions related to things and activities that users like or dislike, such as types of music a user enjoys, dancing preference, party-going preference, certain sports that a user plays, video game preferences, etc. Other questions may be related to the users' diet preferences such as like or dislike a certain type of food (e.g., ice cream, egg). A survey related to habits and lifestyle may include questions regarding smoking habits, alcohol consumption and frequency, daily exercise duration, sleeping habits (e.g., morning person versus night person), sleeping cycles and problems, hobbies, and travel preferences. Additional environmental factors may include diet amount (calories, macronutrients), physical fitness abilities (e.g., stretching, flexibility, heart rate recovery), family type (adopted family or not, has siblings or not, lived with extended family during childhood), property and item ownership (has home or rents, has a smartphone or doesn't, has a car or doesn't).

Surveys also may be related to other environmental factors such as geographical, social-economic, or cultural factors. Geographical questions may include questions related to the birth location, family migration history, town, or city of users' current or past residence. Social-economic questions may be related to users' education level, income, occupations, self-identified demographic groups, etc. Questions related to culture may concern users' native language, language spoken at home, customs, dietary practices, etc. Other questions related to users' cultural and behavioral questions are also possible.

For any survey questions asked, the computing server 130 may also ask an individual the same or similar questions regarding the traits and environmental factors of the ancestors, family members, other relatives or friends of the individual. For example, a user may be asked about the native language of the user and the native languages of the user's parents and grandparents. A user may also be asked about the health history of his or her family members.

In addition to storing the survey data in the individual profile store 210, the computing server 130 may store some responses that correspond to data related to genealogical and genetics respectively to genealogy data store 200 and genetic data store 205.

The user profile data, photos of users, survey response data, the genetic data, and the genealogy data may be subject to the privacy and authorization setting of the users to specify any data related to the users that can be accessed, stored, obtained, or otherwise used. For example, when presented with a survey question, a user may select to answer or skip the question. The computing server 130 may present users from time to time information regarding users' selection of the extent of information and data shared. The computing server 130 also may maintain and enforce one or more privacy settings for users in connection with the access of the user profile data, photos, genetic data, and other sensitive data. For example, the user may pre-authorize the access to the data and may change the setting as wished. The privacy settings also may allow a user to specify (e.g., by opting out, by not opting in) whether the computing server 130 may receive, collect, log, or store particular data associated with the user for any purpose. A user may restrict her data at various levels. For example, on one level, the data may not be accessed by the computing server 130 for purposes other than displaying the data in the user's own profile. On another level, the user may authorize anonymization of her data and participate in studies and research conducted by the computing server 130 such as a large-scale genetic study. On yet another level, the user may turn some portions of her genealogy data public to allow the user to be discovered by other users (e.g., potential relatives) and be connected to one or more family trees. Access or sharing of any information or data in the computing server 130 may also be subject to one or more similar privacy policies. A user's data and content objects in the computing server 130 may also be associated with different levels of restriction. The computing server 130 may also provide various notification features to inform and remind users of their privacy and access settings. For example, when privacy settings for a data entry allow a particular user or other entities to access the data, the data may be described as being “visible,” “public,” or other suitable labels, contrary to a “private” label.

In some cases, the computing server 130 may have heightened privacy protection on certain types of data and data related to certain vulnerable groups. In some cases, the heightened privacy settings may strictly prohibit the use, analysis, and sharing of data related to a certain vulnerable group. In other cases, the heightened privacy settings may specify that data subject to those settings require prior approval for access, publication, or other use. In some cases, the computing server 130 may provide heightened privacy as a default setting for certain types of data, such as genetic data or any data that the user marks as sensitive. The user may opt in to sharing those data or change the default privacy settings. In other cases, the heightened privacy settings may apply across the board for all data of certain groups of users. For example, if computing server 130 determines that the user is a minor or has recognized that a picture of a minor is uploaded, the computing server 130 may designate all profile data associated with the minor as sensitive. In those cases, the computing server 130 may have one or more extra steps in seeking and confirming any sharing or use of the sensitive data.

In some embodiments, the individual profile store 210 may be a large-scale data store. In some embodiments, the individual profile store 210 may include at least 10,000 data records in the form of user profiles and one or more user profiles may be associated with one or more inheritance datasets and one or more genealogical data entries. In some embodiments, the individual profile store 210 may include at least 50,000 data records in the form of user profiles and one or more user profiles may be associated with one or more inheritance datasets and one or more genealogical data entries. In some embodiments, the individual profile store 210 may include at least 100,000 data records in the form of user profiles and one or more user profiles may be associated with one or more inheritance datasets and one or more genealogical data entries. In some embodiments, the individual profile store 210 may include at least 500,000 data records in the form of user profiles and one or more user profiles may be associated with one or more inheritance datasets and one or more genealogical data entries. In some embodiments, the individual profile store 210 may include at least 1,000,000 data records in the form of user profiles and one or more user profiles may be associated with one or more inheritance datasets and one or more genealogical data entries. In some embodiments, the individual profile store 210 may include at least 2,000,000 data records in the form of user profiles and one or more user profiles may be associated with one or more inheritance datasets and one or more genealogical data entries. In some embodiments, the individual profile store 210 may include at least 5,000,000 data records in the form of user profiles and one or more user profiles may be associated with one or more inheritance datasets and one or more genealogical data entries. In some embodiments, the individual profile store 210 may include at least 10,000,000 data records in the form of user profiles and one or more user profiles may be associated with one or more inheritance datasets and one or more genealogical data entries.

The sample pre-processing engine 215 receives and pre-processes data received from various sources to change the data into a format used by the computing server 130. For genealogy data, the sample pre-processing engine 215 may receive data from an individual via the user interface 115 of the client device 110. To collect the user data (e.g., genealogical and survey data), the computing server 130 may cause an interactive user interface on the client device 110 to display interface elements in which users can provide genealogy data and survey data. Additional data may be obtained from scans of public records. The data may be manually provided or automatically extracted via, for example, optical character recognition (OCR) performed on census records, town or government records, or any other item of printed or online material. Some records may be obtained by digitalizing written records such as older census records, birth certificates, death certificates, etc.

The sample pre-processing engine 215 may also receive raw data from the genetic data extraction service server 125. The genetic data extraction service server 125 may perform laboratory analysis of biological samples of users and generate sequencing results in the form of digital data. The sample pre-processing engine 215 may receive the raw inheritance datasets from the genetic data extraction service server 125. Most of the mutations that are passed down to descendants are related to single-nucleotide polymorphism (SNP). SNP is a substitution of a single nucleotide that occurs at a specific position in the genome. The sample pre-processing engine 215 may convert the raw base pair sequence into a sequence of genotypes of target SNP sites. Alternatively, the pre-processing of this conversion may be performed by the genetic data extraction service server 125. The sample pre-processing engine 215 identifies autosomal SNPs in an individual's inheritance dataset. In some embodiments, the SNPs may be autosomal SNPs. In some embodiments, 700,000 SNPs may be identified in an individual's data and may be stored in genetic data store 205. Alternatively, in some embodiments, an inheritance dataset may include at least 10,000 SNP sites. In another embodiment, an inheritance dataset may include at least 100,000 SNP sites. In yet another embodiment, an inheritance dataset may include at least 300,000 SNP sites. In yet another embodiment, an inheritance dataset may include at least 1,000,000 SNP sites. The sample pre-processing engine 215 may also convert the nucleotides into bits. The identified SNPs, in bits or in other suitable formats, may be provided to the phasing engine 220 which phases the individual's diploid genotypes to generate a pair of haplotypes for each user.

The phasing engine 220 phases a diploid inheritance dataset into a pair of haploid inheritance datasets and may perform imputation of SNP values at certain sites whose alleles are missing. An individual's haplotype may refer to a collection of alleles (e.g., a sequence of alleles) that are inherited from a parent.

Phasing may include a process of determining the assignment of alleles (particularly heterozygous alleles) to chromosomes. Owing to conditions and other constraints in sequencing or microarray, a DNA identification result often includes data regarding a pair of alleles at a given SNP locus of a pair of chromosomes but may not be able to distinguish which allele belongs to which specific chromosome. The phasing engine 220 uses a genotype phasing algorithm to assign one allele to a first chromosome and another allele to another chromosome. The genotype phasing algorithm may be developed based on an assumption of linkage disequilibrium (LD), which states that haplotype in the form of a sequence of alleles tends to cluster together. The phasing engine 220 is configured to generate phased sequences that are also commonly observed in many other samples. Put differently, haplotype sequences of different individuals tend to cluster together. A haplotype-cluster model may be generated to determine the probability distribution of a haplotype that includes a sequence of alleles. The haplotype-cluster model may be trained based on labeled data that includes known phased haplotypes from a trio (parents and a child). A trio is used as a training sample because the correct phasing of the child is almost certain by comparing the child's genotypes to the parent's inheritance datasets. The haplotype-cluster model may be generated iteratively along with the phasing process with a large number of unphased genotype datasets. The haplotype-cluster model may also be used to impute one or more missing data.

By way of example, the phasing engine 220 may use a directed acyclic graph model such as a hidden Markov model (HMM) to perform the phasing of a target genotype dataset. The directed acyclic graph may include multiple levels, each level having multiple nodes representing different possibilities of haplotype clusters. An emission probability of a node, which may represent the probability of having a particular haplotype cluster given an observation of the genotypes may be determined based on the probability distribution of the haplotype-cluster model. A transition probability from one node to another may be initially assigned to a non-zero value and be adjusted as the directed acyclic graph model and the haplotype-cluster model are trained. Various paths are possible in traversing different levels of the directed acyclic graph model. The phasing engine 220 determines a statistically likely path, such as the most probable path or a probable path that is at least more likely than 95% of other possible paths, based on the transition probabilities and the emission probabilities. A suitable dynamic programming algorithm such as the Viterbi algorithm may be used to determine the path. The determined path may represent the phasing result. U.S. Pat. No. 10,679,729, entitled “Haplotype Phasing Models,” granted on Jun. 9, 2020, describes example embodiments of haplotype phasing.

A phasing algorithm may also generate phasing result that has a long genomic distance accuracy and cross-chromosome accuracy in terms of haplotype separation. For example, in some embodiments, an IBD-phasing algorithm may be used, which is described in further detail in U.S. Patent Application Publication No. US 2021/0034647, entitled “Clustering of Matched Segments to Determine Linkage of Dataset in a Database,” published on Feb. 4, 2021. For example, the computing server 130 may receive a target individual genotype dataset and a plurality of additional individual genotype datasets that include haplotypes of additional individuals. For example, the additional individuals may be reference panels or individuals who are linked (e.g., in a family tree) to the target individual. The computing server 130 may generate a plurality of sub-cluster pairs of first parental groups and second parental groups. Each sub-cluster pair may be in a window. The window may correspond to a genomic segment and has a similar concept of window used in the ethnicity estimation engine 245 and the rest of the disclosure related to HMMs, but how windows are precisely divided and defined may be the same or different in the phasing engine 220 and in an HMM. Each sub-cluster pair may correspond to a genetic locus. In some embodiments, each sub-cluster pair may have a first parental group that includes a first set of matched haplotype segments selected from the plurality of additional individual datasets and a second parental group that includes a second set of matched haplotype segments selected from the plurality of additional individual datasets. The computing server 130 may generate a super-cluster of a parental side by linking the first parental groups and the second parental groups across a plurality of genetic loci (across a plurality of sub-cluster pairs). Generating the super-cluster of the parental side may include generating a candidate parental side assignment of parental groups across a set of sub-cluster pairs that represent a set of genetic loci in the plurality of genetic loci. The computing server 130 may determine the number of common additional individual genotype datasets that are classified in the candidate parental side assignment. The computing server 130 may determine the candidate parental side assignment to be part of the super-cluster based on the number of common additional individual genotype datasets. Any suitable algorithms may be used to generate the super-cluster, such as a heuristic scoring approach, a bipartite graph approach, or another suitable approach. The computing server 130 may generate a haplotype phasing of the target individual from the super-cluster of the parental side.

The IBD estimation engine 225 estimates the amount of shared genetic segments between a pair of individuals based on phased genotype data (e.g., haplotype datasets) that are stored in the genetic data store 205. IBD segments may be segments identified in a pair of individuals that are putatively determined to be inherited from a common ancestor. The IBD estimation engine 225 retrieves a pair of haplotype datasets for each individual. The IBD estimation engine 225 may divide each haplotype dataset sequence into a plurality of windows. Each window may include a fixed number of SNP sites (e.g., about 100 SNP sites). The IBD estimation engine 225 identifies one or more seed windows in which the alleles at all SNP sites in at least one of the phased haplotypes between two individuals are identical. The IBD estimation engine 225 may expand the match from the seed windows to nearby windows until the matched windows reach the end of a chromosome or until a homozygous mismatch is found, which indicates the mismatch is not attributable to potential errors in phasing or imputation. The IBD estimation engine 225 determines the total length of matched segments, which may also be referred to as IBD segments. The length may be measured in the genetic distance in the unit of centimorgans (cM). A unit of centimorgan may be a genetic length. For example, two genomic positions that are one cM apart may have a 1% chance during each meiosis of experiencing a recombination event between the two positions. The computing server 130 may save data regarding individual pairs who share a length of IBD segments exceeding a predetermined threshold (e.g., 6 cM), in a suitable data store such as in the genealogy data store 200. U.S. Pat. No. 10,114,922, entitled “Identifying Ancestral Relationships Using a Continuous stream of Input,” granted on Oct. 30, 2018, and U.S. Pat. No. 10,720,229, entitled “Reducing Error in Predicted Genetic Relationships,” granted on Jul. 21, 2020, describe example embodiments of IBD estimation.

Typically, individuals who are closely related share a relatively large number of IBD segments, and the IBD segments tend to have longer lengths (individually or in aggregate across one or more chromosomes). In contrast, individuals who are more distantly related share relatively fewer IBD segments, and these segments tend to be shorter (individually or in aggregate across one or more chromosomes). For example, while close family members often share upwards of 71 cM of IBD (e.g., third cousins), more distantly related individuals may share less than 12 cM of IBD. The extent of relatedness in terms of IBD segments between two individuals may be referred to as IBD affinity. For example, the IBD affinity may be measured in terms of the length of IBD segments shared between two individuals.

Community assignment engine 230 assigns individuals to one or more genetic communities based on the genetic data of the individuals. A genetic community may correspond to an ethnic origin or a group of people descended from a common ancestor. The granularity of genetic community classification may vary depending on embodiments and methods used to assign communities. For example, in some embodiments, the communities may be African, Asian, European, etc. In another embodiment, the European community may be divided into Irish, German, Swedes, etc. In yet another embodiment, the Irish may be further divided into Irish in Ireland, Irish who immigrated to America in 1800, Irish who immigrated to America in 1900, etc. The community classification may also depend on whether a population is admixed or unadmixed. For an admixed population, the classification may further be divided based on different ethnic origins in a geographical region.

Community assignment engine 230 may assign individuals to one or more genetic communities based on their inheritance datasets using machine learning models trained by unsupervised learning or supervised learning. In an unsupervised approach, the community assignment engine 230 may generate data representing a partially connected undirected graph. In this approach, the community assignment engine 230 represents individuals as nodes. Some nodes are connected by edges whose weights are based on IBD affinity between two individuals represented by the nodes. For example, if the total length of two individuals' shared IBD segments does not exceed a predetermined threshold, the nodes are not connected. The edges connecting two nodes are associated with weights that are measured based on the IBD affinities. The undirected graph may be referred to as an IBD network. The community assignment engine 230 uses clustering techniques such as modularity measurement (e.g., the Louvain method) to classify nodes into different clusters in the IBD network. Each cluster may represent a community. The community assignment engine 230 may also determine sub-clusters, which represent sub-communities. The computing server 130 saves the data representing the IBD network and clusters in the IBD network data store 235. U.S. Pat. No. 10,223,498, entitled “Discovering Population Structure from Patterns of Identity-By-Descent,” granted on Mar. 5, 2019, describes example embodiments of community detection and assignment.

The community assignment engine 230 may also assign communities using supervised techniques. For example, inheritance datasets of known genetic communities (e.g., individuals with confirmed ethnic origins) may be used as training sets that have labels of the genetic communities. Supervised machine learning classifiers, such as logistic regressions, support vector machines, random forest classifiers, and neural networks may be trained using the training set with labels. A trained classifier may distinguish binary or multiple classes. For example, a binary classifier may be trained for each community of interest to determine whether a target individual's inheritance dataset belongs or does not belong to the community of interest. A multi-class classifier such as a neural network may also be trained to determine whether the target individual's inheritance dataset most likely belongs to one of several possible genetic communities.

Reference panel sample store 240 stores reference panel samples for different genetic communities. A reference panel sample is the genetic data of an individual whose genetic data is the most representative of a genetic community. The genetic data of individuals with typical alleles of a genetic community may serve as reference panel samples. For example, some alleles of genes may be over-represented (e.g., being highly common) in a genetic community. Some inheritance datasets include alleles that are commonly present among members of the community. Reference panel samples may be used to train various machine learning models in classifying whether a target inheritance dataset belongs to a community, determining the ethnic composition of an individual, and determining the accuracy of any genetic data analysis, such as by computing a posterior probability of a classification result from a classifier.

A reference panel sample may be identified in different ways. In some embodiments, an unsupervised approach in community detection may apply the clustering algorithm recursively for each identified cluster until the sub-clusters contain a number of nodes that are smaller than a threshold (e.g., containing fewer than 1000 nodes). For example, the community assignment engine 230 may construct a full IBD network that includes a set of individuals represented by nodes and generate communities using clustering techniques. The community assignment engine 230 may randomly sample a subset of nodes to generate a sampled IBD network. The community assignment engine 230 may recursively apply clustering techniques to generate communities in the sampled IBD network. The sampling and clustering may be repeated for different randomly generated IBD networks for various runs. Nodes that are consistently assigned to the same genetic community when sampled in various runs may be classified as a reference panel sample. The community assignment engine 230 may measure the consistency in terms of a predetermined threshold. For example, if a node is classified to the same community 95% (or another suitable threshold) of the times the node is sampled, the inheritance dataset corresponding to the individual represented by the node may be regarded as a reference panel sample. Additionally, or alternatively, the community assignment engine 230 may select N most consistently assigned nodes as a reference panel for the community.

Other ways to generate reference panel samples are also possible. For example, the computing server 130 may collect a set of samples and gradually filter and refine the samples until high-quality reference panel samples are selected. For example, a candidate reference panel sample may be selected from an individual whose recent ancestors were born at a certain birthplace. The computing server 130 may also draw sequence data from the Human Genome Diversity Project (HGDP). Various candidates may be manually screened based on their family trees, relatives' birth location, and other quality controls. Principal component analysis may be used to create clusters of genetic data of the candidates. Each cluster may represent an ethnicity. The predictions of the ethnicity of those candidates may be compared to the ethnicity information provided by the candidates to perform further screening.

The ethnicity estimation engine 245 estimates the ethnicity composition of an inheritance dataset of a target individual. The inheritance datasets used by the ethnicity estimation engine 245 may be genotype datasets or haplotype datasets. For example, the ethnicity estimation engine 245 estimates the ancestral origins (e.g., ethnicity) based on the individual's genotypes or haplotypes at the SNP sites. To take a simple example of three ancestral populations corresponding to African, European and Native American, an admixed user may have nonzero estimated ethnicity proportions for all three ancestral populations, with an estimate such as [0.05, 0.65, 0.30], indicating that the user's genome is 5% attributable to African ancestry, 65% attributable to European ancestry and 30% attributable to Native American ancestry. The ethnicity estimation engine 245 generates the ethnic composition estimate and stores the estimated ethnicities in a data store of computing server 130 with a pointer in association with a particular user.

In some embodiments, the ethnicity estimation engine 245 divides a target inheritance dataset into a plurality of windows (e.g., about 1000 windows). Each window includes a small number of SNPs (e.g., 300 SNPs). The ethnicity estimation engine 245 may use a directed acyclic graph model to determine the ethnic composition of the target inheritance dataset. The directed acyclic graph may represent a trellis of an inter-window hidden Markov model (HMM). The graph includes a sequence of a plurality of node groups. Each node group, representing a window, includes a plurality of nodes. The nodes represent different possibilities of labels of genetic communities (e.g., ethnicities) for the window. A node may be labeled with one or more ethnic labels. For example, a level includes a first node with a first label representing the likelihood that the window of SNP sites belongs to a first ethnicity and a second node with a second label representing the likelihood that the window of SNPs belongs to a second ethnicity. Each level includes multiple nodes so that there are many possible paths to traverse the directed acyclic graph.

The nodes and edges in the directed acyclic graph may be associated with different emission probabilities and transition probabilities. An emission probability associated with a node represents the likelihood that the window belongs to the ethnicity labeling the node given the observation of SNPs in the window. The ethnicity estimation engine 245 determines the emission probabilities by comparing SNPs in the window corresponding to the target inheritance dataset to corresponding SNPs in the windows in various reference panel samples of different genetic communities stored in the reference panel sample store 240. The transition probability between two nodes represents the likelihood of transition from one node to another across two levels. The ethnicity estimation engine 245 determines a statistically likely path, such as the most probable path or a probable path that is at least more likely than 95% of other possible paths, based on the transition probabilities and the emission probabilities. A suitable dynamic programming algorithm such as the Viterbi algorithm or the forward-backward algorithm may be used to determine the path. After the path is determined, the ethnicity estimation engine 245 determines the ethnic composition of the target inheritance dataset by determining the label compositions of the nodes that are included in the determined path. U.S. Pat. No. 10,558,930, entitled “Local Genetic Ethnicity Determination System,” granted on Feb. 11, 2020, and U.S. Pat. No. 10,692,587, granted on Jun. 23, 2020, entitled “Global Ancestry Determination System” describe different example embodiments of ethnicity estimation.

The tree management engine 250 performs computations and other processes related to users' management of their data trees such as family trees. The tree management engine 250 may allow a user to build a data tree from scratch or to link the user to existing data trees. In some embodiments, the tree management engine 250 may suggest a connection between a target individual and a family tree that exists in the family tree database by identifying potential family trees for the target individual and identifying one or more most probable positions in a potential family tree. A user (target individual) may wish to identify family trees to which he or she may potentially belong. Linking a user to a family tree or building a family may be performed automatically, manually, or using techniques with a combination of both. In an embodiment of an automatic tree matching, the tree management engine 250 may receive an inheritance dataset from the target individual as input and search related individuals that are IBD-related to the target individual. The tree management engine 250 may identify common ancestors. Each common ancestor may be common to the target individual and one of the related individuals. The tree management engine 250 may in turn output potential family trees to which the target individual may belong by retrieving family trees that include a common ancestor and an individual who is IBD-related to the target individual. The tree management engine 250 may further identify one or more probable positions in one of the potential family trees based on information associated with matched genetic data between the target individual and those in the potential family trees through one or more machine learning models or other heuristic algorithms. For example, the tree management engine 250 may try putting the target individual in various possible locations in the family tree and determine the highest probability position(s) based on the inheritance dataset of the target individual and inheritance datasets available for others in the family tree and based on genealogy data available to the tree management engine 250. The tree management engine 250 may provide one or more family trees from which the target individual may select. For a suggested family tree, the tree management engine 250 may also provide information on how the target individual is related to other individuals in the tree. In a manual tree building, a user may browse through public family trees and public individual entries in the genealogy data store 200 and individual profile store 210 to look for potential relatives that can be added to the user's family tree. The tree management engine 250 may automatically search, rank, and suggest individuals for the user conduct manual reviews as the user makes progress in the front-end interface 260 in building the family tree.

As used herein, “pedigree” and “family tree” may be interchangeable and may refer to a family tree chart or pedigree chart that shows, diagrammatically, family information, such as family history information, including parentage, offspring, spouses, siblings, or otherwise for any suitable number of generations and/or people, and/or data pertaining to persons represented in the chart. U.S. Pat. No. 11,429,615, entitled “Linking Individual Datasets to a Database,” granted on Aug. 30, 2022, describes example embodiments of how an individual may be linked to existing family trees.

The front-end interface 260 may render a front-end platform that displays various results determined by the computing server 130. The platform may take the form of a genealogy research and family tree building platform and/or a personal DNA data analysis platform. The platform may also serve as a social networking system that allows users and connect and build family trees and research family relations together. The results and data may include the IBD affinity between a user and another individual, the community assignment of the user, the ethnicity estimation of the user, phenotype prediction and evaluation, genealogy data search, family tree and pedigree, relative profile and other information. The front-end interface 260 may allow users to manage their profile and data trees (e.g., family trees). The users may view various public family trees stored in the computing server 130 and search for individuals and their genealogy data via the front-end interface 260. The computing server 130 may suggest or allow the user to manually review and select potentially related individuals (e.g., relatives, ancestors, close family members) to add to the user's data tree. The front-end interface 260 may be a graphical user interface (GUI) that displays various information and graphical elements.

The front-end interface 260 may take different forms. In one case, the front-end interface 260 may be a software application that can be displayed on an electronic device such as a computer or a smartphone. The software application may be developed by the entity controlling the computing server 130 and be downloaded and installed on the client device 110. In another case, the front-end interface 260 may take the form of a webpage interface of the computing server 130 that allows users to access their family tree and genetic analysis results through web browsers. In yet another case, the front-end interface 260 may provide an application program interface (API). In some embodiments, the front-end interface 260 may be rendered as part of the content in an extended reality device, such as a head-mounted display or a phone camera that is integrated with augmented reality features.

The front-end interface 260 may provide various front-end visualization features. In some embodiments, a family tree viewer may render family tree built by users and/or managed by the tree management engine 250. The family tree may be displayed in a nested nodes and edges connected based on family relationships or genetic matches determined by various genetic data analysis engines discussed in FIG. 2. The family trees may include attached records that are part of records in the genealogy data store 200, including records that are uploaded by users and gallery images. The user may assign a focal person to a family tree and the family tree is displayed with the focus (such as positioning the focal person at the center or relative prominent position of the tree) around the focal person. A user may change the focal person and the family tree may shift accordingly based on the relationships and relative positions of members in the family tree. Each person in the family tree may be associated with historical photos from gallery images, historical genealogy records such as life event records, one or more stories and live events associated with the person, and metadata such as family relationships and other family trees associated with the person.

In some embodiments, visualization features provided by the front-end interface 260 may include a map feature. A map may be a geographical map that may take the form of a digital map, a historical physical map, and/or a historical map overlaid on a digital map. A user may select a geographical location and the front-end interface 260 displays relevant genealogical or genetic records associated with the location, such as an ancestor's lifetime events, birth locations of DNA matches, mitigation patterns of ancestors across different locations over time and associated genealogical records, residence maps that provide specific locations of historical persons' events, and historical maps overlaying on a digital map to contextualize ancestors' records and events. The map feature may also provide interactive features to allow users to view historical documents, photographs, and stores associated with the geographical locations. The map feature may also allow users to adjust timeframes, displaying changes in locations and migrations over different periods.

In some embodiments, visualization features provided by the front-end interface 260 may include a story feature that provides multimedia narratives about a person, such as the person's live events and family history. The story feature allows a user to compile various graphical and genealogical elements such as photos, documents, historical records, and personal anecdotes into a timeline to summarize a narrative. The story may be arranged in an appropriate spatial manner such as a linear arrangement that arranges various graphical elements based on the creator's selection.

In this disclosure, genetic data may be an example of inheritance data. An individual is an example of a named entity. A genetic sequence is an example of data string or bit string. A genetic segment is an example of data string segment. A matched genetic segment is an example of matched data string. For example, an IBD segment is an example of a matched data string segment. An ethnicity is an example or a data origin or a data classification. A phenotype is an example of a data manifestation. A reproductive event is an example of a data inheritance event.

### Community Assignment Using a Trained Model

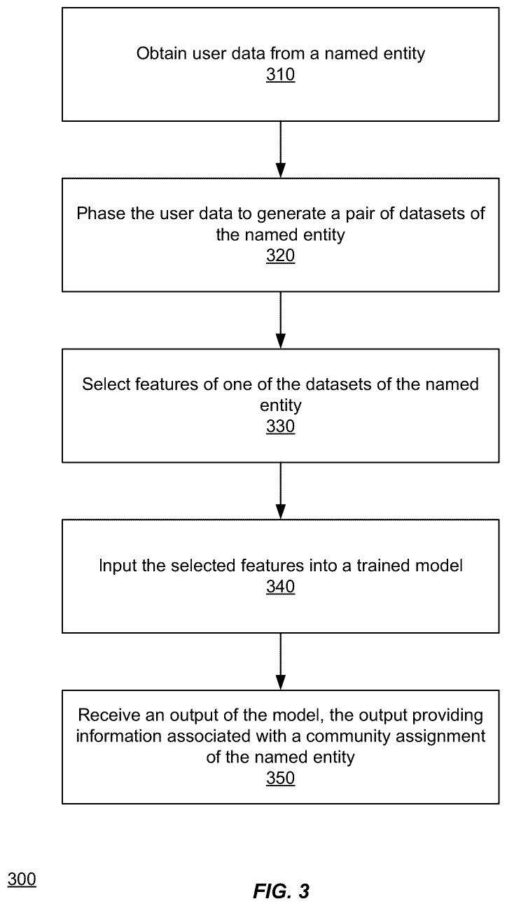

FIG. 3 is a flowchart illustrating a method 300 of using a model to predict if an individual is a member of a community, in accordance with some embodiments. The process may be performed by one or more engines of the computing server 130 illustrated in FIG. 2, such as the community assignment engine 230 in combination of other engines such as phasing engine 220, IBD estimation engine 225, IBD network data store 235, reference panel sample store 240, and ethnicity estimation engine 245. The process 300 may be embodied as a software algorithm that may be stored as computer instructions that are executable by one or more processors. The instructions, when executed by the processors, cause the processors to perform various steps in the process 300. In various embodiments, the process may include additional, fewer, or different steps. While various steps in process 300 may be discussed with the use of computing server 130, each step may be performed by a different computing device. While in the discussion below the genetic dataset (such as diploid, haploid, genotype data) is used as the main example of a user dataset, various embodiments may also apply to other suitable user datasets.

In some embodiments, process 300 can include obtaining 310 user data from a named entity. For example, the user data may be a genetic dataset from an individual. The genetic dataset may be in a form of diploid data that includes a sequencing of genotypes, such as genotypes at the target SNP site, or the whole base-pair sequence that includes genotypes at known SNP sites and other base pair sites that are not commonly associated with known SNPs. The diploid dataset may be referred to as a genotype dataset or a genotype sequence. It will be appreciated that while diploid SNP microarray-based genetic datasets are described herein, the disclosure is not limited thereto, but rather extends to any suitable user data.

Continuing with reference to FIG. 3, in some embodiments, process 300 can include phasing 320 the user data to generate a pair of datasets of or corresponding to the named entity. In some embodiments, the diploid dataset may be phased into a pair of datasets of the individual that each comprise haploid data. Each of the pair of datasets of the phased datasets may be referred to as a haplotype dataset, a haplotype sequence, or a haploid dataset, as suitable. One of the haplotype datasets corresponds to one of the individual's parent's genetic information and the other one of the haplotype datasets corresponds to the individual's other parent's genetic information. In some embodiments, phasing may be carried out by a phasing pipeline that generates a phasing result that has a long-distance accuracy in terms of haplotype separation. For example, in some embodiments, an IBD phasing approach may be used, which is described in further detail in U.S. Patent Application Publication No. US 2021/0034647, entitled “Clustering of Matched Segments to Determine Linkage of Dataset in a Database,” published on Feb. 4, 2021, and/or in U.S. Pat. No. 12,050,629, granted on Jul. 30, 2024.

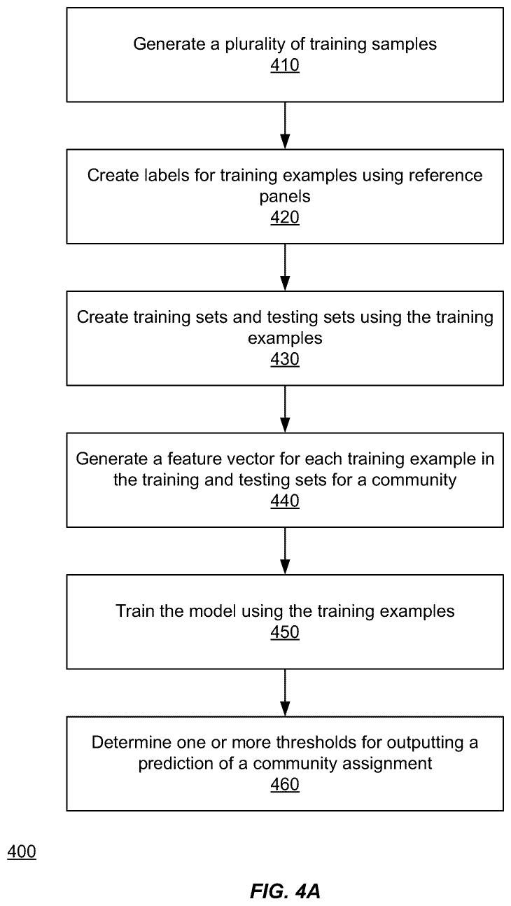

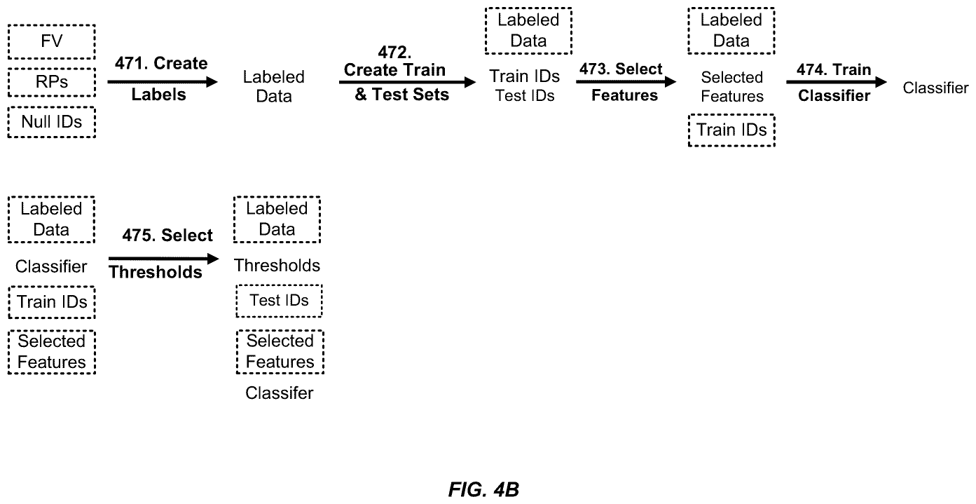

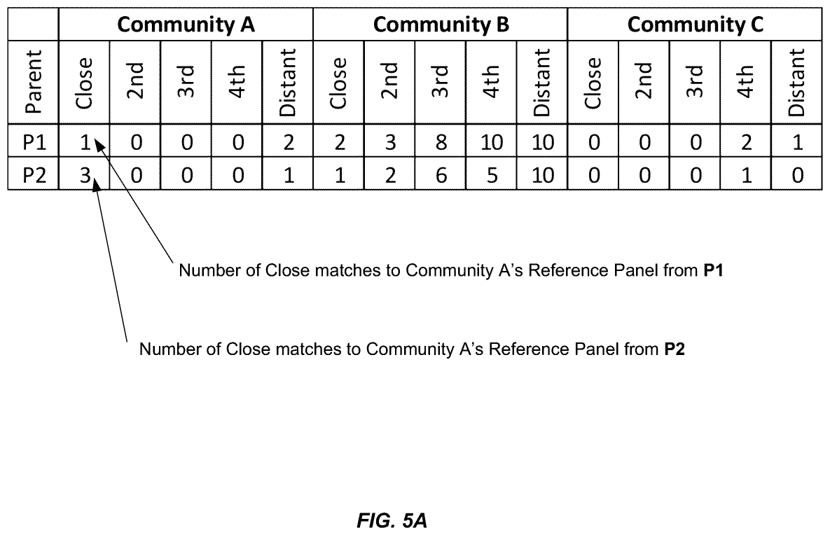

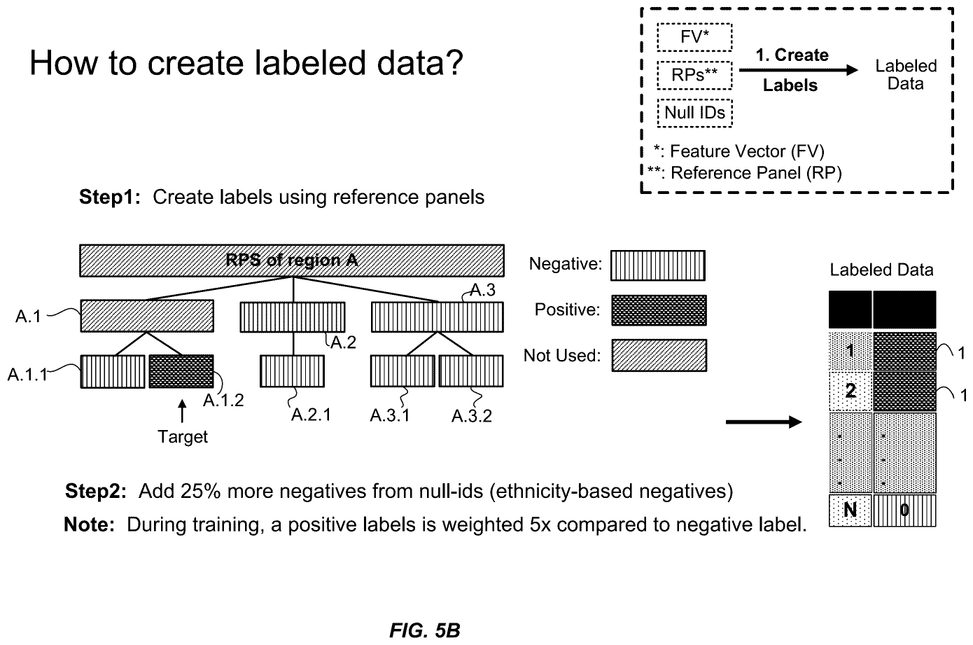

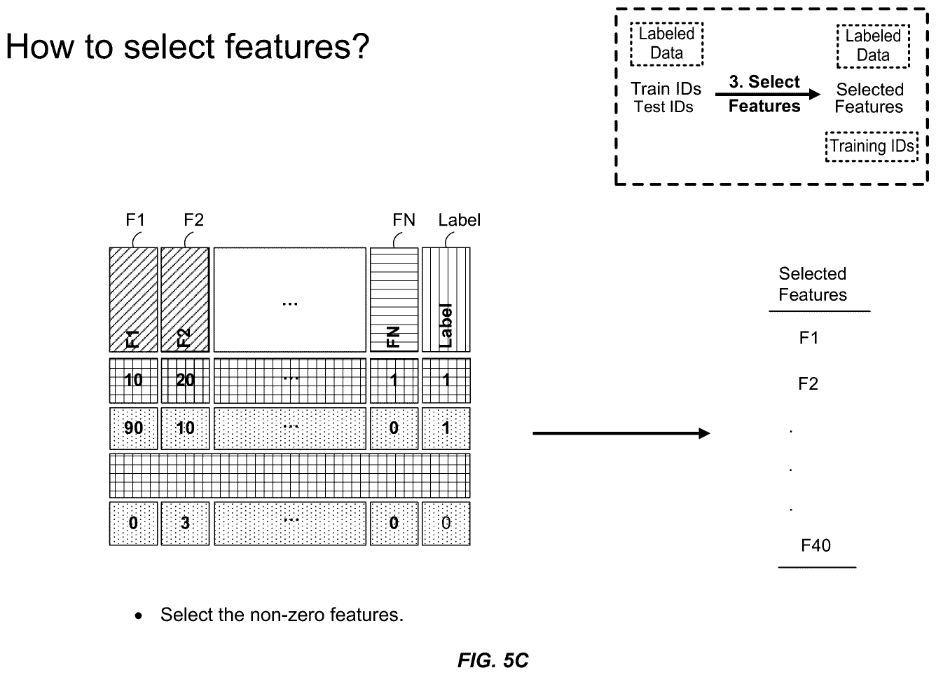

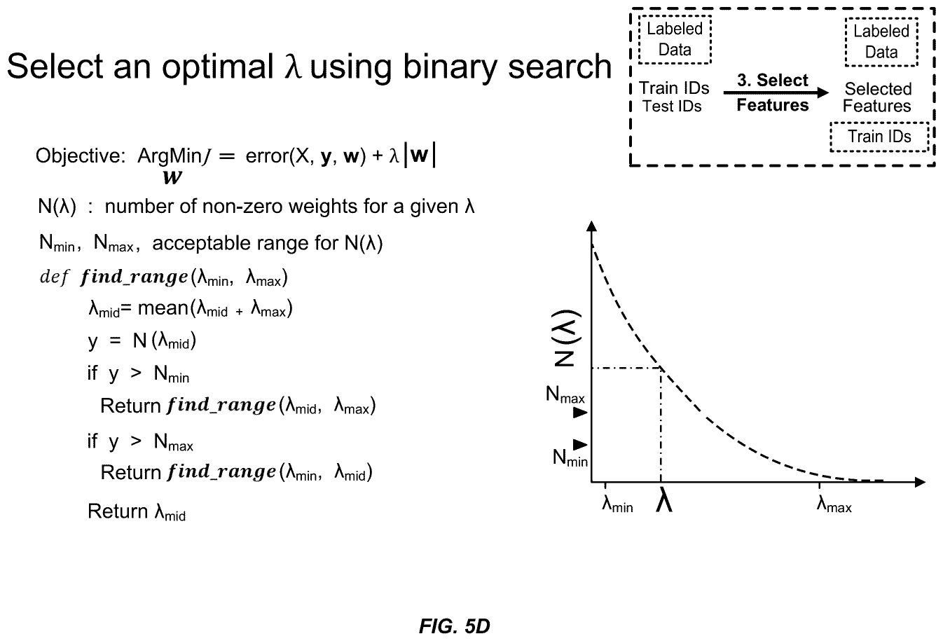

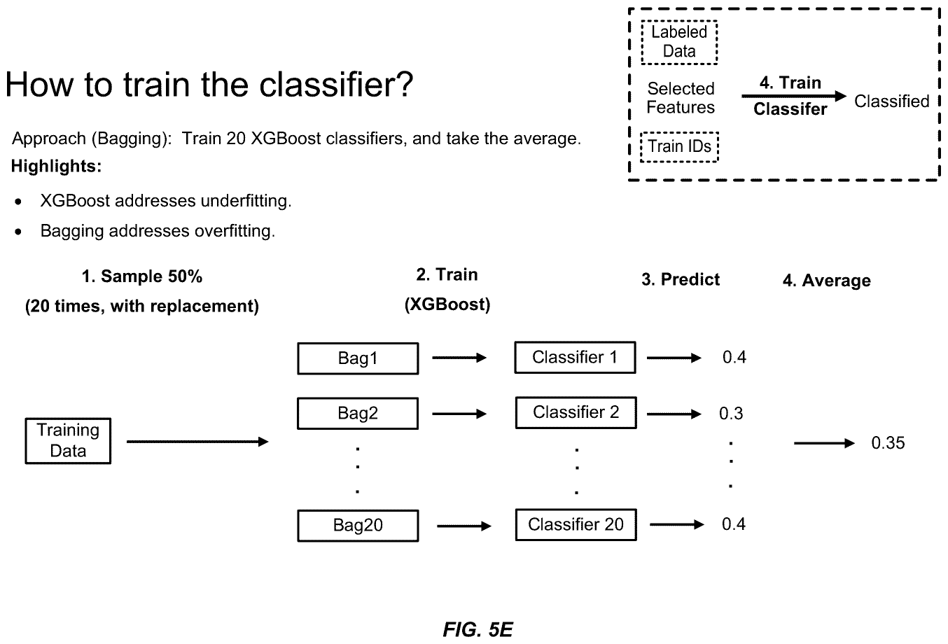

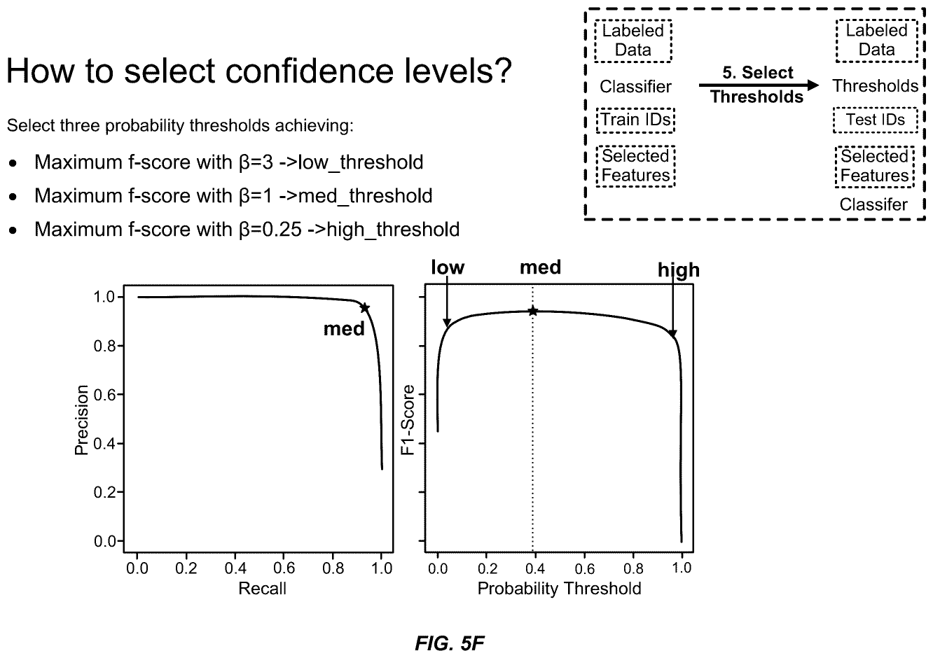

Continuing with reference to FIG. 3, in some embodiments, process 300 can include selecting 330 features of each dataset of the pair of datasets of the named entity. Each dataset may be a haplotype dataset phased from the genotype of the individual and the features are selected or extracted based on and/or from the haplotype. Since the individual has or is associated with a pair of phased haplotypes, the feature-selection step 330 may be repeated for each haplotype that is inherited from a parent. The selection of features based on a haplotype may be part of a feature-selection process in machine learning. In some embodiments, the haplotype sequence or sub-segments thereof may serve as part of the extracted features and used as part of the input for a community classifier model. In some embodiments, the haplotype sequence or sub-segments thereof are not directly inputted into a community classifier model. Instead, the haplotype is compared to individuals in the community and the comparison results may serve as the features for selection. For example, using the IBD estimation engine 225, the computing server 130 may determine the number of the haplotype's IBD matches who belong to the communities and classify those matches into buckets based on relatedness. The relatedness may be defined based on the range of cumulative cM shared between the individual's haplotype and the IBD match. The number of matches in each bucket may serve as a feature. Further detail of the feature selection will be discussed below in association with FIGS. 4, 5A, 5C, and 5D.

Continuing with reference to FIG. 3, in some embodiments, process 300 can include inputting 340 the selected features into a trained community classifier model, which may simply be referred to as a model. For example, the computing server 130 may format the features of a haplotype of the individual as a feature vector that serves as the input of the trained model. In some embodiments, the trained model is a machine learning (ML) model. In some embodiments, the model is trained with a training set that includes a plurality of training samples. Each training sample may include haplotype data of a reference individual and a label identifying whether the reference individual belongs to a community. An individual having the selected haplotype dataset that is representative of a community may be determined as a reference individual who belongs to the community, e.g. a positive sample.

A reference individual of a community may be part of a reference panel of the community. In some embodiments, construction of a reference panel of a community may start with a geographical region that includes a hierarchy of associated communities. Individual communities in the hierarchy may be identified by the community assignment engine 230. The hierarchy may be represented as a tree of communities. A target community can be any node, such as a leaf node in the hierarchy. Any individual may be classified into zero, one, or multiple communities in the hierarchy. For a leaf node representing a particular community, the reference panel may be or comprise individuals who are uniquely assigned to that particular community. For example, if an individual is assigned by, e.g., the community assignment engine 230, to two sister communities in the hierarchy, that individual may not used as part of the reference panel for either community. Further detail of constructing a reference panel in this particular way is discussed below with reference to FIG. 5B. Alternatively, or additionally, a reference individual may be selected from a reference panel in the reference panel sample store 240. Alternatively, or additionally, a reference individual may be someone who is known to belong to a community. For example, the computing server 130 may determine whether a candidate individual is qualified as a reference individual through reviewing the genealogy data in the genealogy data store 200 and the family tree data of the individual managed by the tree management engine 260.

Continuing with reference to FIG. 3, in some embodiments, process 300 can include receiving 350 an output from the model. The output provides information associated with a community assignment of the named entity for or associated with each haplotype. The output from the model may include an outcome corresponding to each haplotype, e.g., whether the haplotype of the individual (or put differently, the genetic materials inherited from a particular parent) belongs to a community. The second haplotype may be analyzed in the same fashion and another output may be obtained from the model. The computing server 130 may store multiple communities and each community may have a model specificd trained for that community. The process 300 may be repeated for various communities to see how many communities to which the individual is assigned for each haplotype.

In some embodiments, the model may assign a level of confidence to the outcome from a model, such as low, medium, and high. In some embodiments, the level of confidence may be associated with a likelihood that the individual belongs to the community. Based on the outcomes and the level of confidence, the output from the model may indicate whether the individual is a member of the community. The output determination may also include combining the results of both haplotypes.

For example, if the model predicts that the individual belongs to a community with a high confidence score based on both haplotype datasets, the output from the model may indicate that the individual belongs to the community. In another example, if the model predicts that the individual belongs to a community with a low confidence score based on cither haplotype dataset, the model and/or computing server 130 may not assign the individual to the community, and the output may indicate that the individual does not belong to the community. In another example, if the model predicts that the individual belongs to a community with a high confidence score based on one haplotype dataset but with a low confidence score based on the other haplotype dataset, the model and/or computing server 130 may assign the individual to the community and attribute the community inheritance to the parent corresponding to the haplotype with the high confidence score. In some embodiments, the output may indicate that an individual belongs to one community based on one haplotype dataset corresponding to one parent and that the individual belongs to another community based on the other haplotype dataset corresponding the other parent. To determine if an individual is a member of additional communities, different subsets of haplotypes are inputted into different community-specific models. Different subsets of haplotypes may correspond to different genetic communities. For example, there may be models to determine if an individual belongs to an Irish community, a Jewish community, or a Finnish community. In one example, a first subset of haplotypes of an individual may be input to the model for the Irish community, a second subset of haplotypes may be input to the model for the Jewish community, and a third subset of haplotypes may be input to the model for the Finnish communities. Based on the output and the associated confidence score from each of the three models, the individual may be assigned to one, two or all three communities; alternatively, the individual may be determined not to belong to any of the communities.

In some embodiments, the computing server 130 may determine one or more thresholds for outputting a prediction of community assignment. After the community classifiers have been trained, for each community classifier, the computing server 130 may input a set of features associated with a haplotype of a target individual into the community classifier to determine whether the target individual belongs to the community. This may include computing a score such as a probability for each model. In some embodiments, an individual is classified as belonging to a given community if the probability computed by the trained model exceeds a threshold numerical value. In one example, a probability threshold may be selected based on the parameters in the training process, such as achieving a recall of 0.5 or more, a precision of 0.2 or more, a maximum f-score, with beta=3, and the like. The threshold for classifying an individual to a community may be the same or different for each model. In some embodiments, the output may include both a binary classification that an individual belongs to a community and the probability for each community. In some embodiments, the output of the community prediction may include both the classification and the posterior probability for each community (e.g., the confidence level on whether the classification is correct). By running the data of the target individual through a number of community classifier models, multiple community assignments may be obtained. In some embodiments, the prediction may include one or more community assignments. For example, an individual may be predicted to belong to an Irish community, a Jewish community and a Finnish community.

### Training of Community Classifier Model

FIG. 4A is a flowchart depicting an example process 400 for training a haploid community assignment ML model, in accordance with some embodiments. A haploid community assignment ML model may refer to a machine learning model that is trained for determining whether a haplotype belongs to a community. The process may be performed by one or more engines of the computing server 130 illustrated in FIG. 2, such as the community assignment engine 230. The process 400 may be embodied as a software algorithm that may be stored as computer instructions that are executable by one or more processors. The instructions, when executed by the processors, cause the processors to perform various steps in the process 400. In various embodiments, the process may include additional, fewer, or different steps. While various steps in process 400 may be discussed with the use of computing server 130, each step may be performed by a different computing device.

The computing server 130 may generate 410 a plurality of training samples. Each training sample may be associated with a haplotype dataset of a named entity who has genetic data stored in the computing server 130. In embodiments, one or more haplotype datasets are generated from simulations. The computing server 130 may generate a training set based on the genetic data stored in the genetic data store 205. In some embodiments, a training set may be community-specific and each community may have its own training set. While in the discussion below the genetic dataset (such as diploid, haploid, genotype data) is used as the main example of user dataset, various embodiments may also apply to other suitable user datasets.

In some embodiments, whether an individual of or associated with a training sample belongs to a community may be based on the ethnicity composition of the individual. For example, to generate a training set for a model for a French community, the computing server 130 may select genetic data from the genetic data store 205 that comprises (based on an ethnicity assignment generated using, e.g. Ethnicity Estimation Engine 245) at least a certain percentage of French genetic data, e.g., 15%, to form the training set, and may then label the individual with such genetic data with a positive label, i.e., identifying that the individual belongs to said French community. Additionally, or alternatively, negative labels may be assigned to individuals with less than the thresholds of the ethnicity criterion that is used to select the individuals for the positive labels. In this case, a person with less than 15% of French genetic data (as determined by, e.g., the Ethnicity Estimation Engine 245) is labeled as negative, i.e., not belonging to said French community. In some embodiments, the label determination may be based on one or more thresholds. For example, using the threshold of 15%, individuals with haplotypes that have more than 15% of genetic data of a community are assigned with positive labels while individuals with haplotypes that have less than 15% of genetic data of the community are assigned with negative labels. In some embodiments, two thresholds may be used. For example, individuals with haplotypes that have more than an upper threshold (e.g., 15%) of genetic data of a community are assigned with positive labels while individuals with haplotypes that have less than a lower threshold (e.g., 5%) of genetic data of the community are assigned with negative labels. Individuals whose haplotypes fall between the range of the upper and lower thresholds may be disregarded in the training purposes or may be assigned positive or negative using additional criteria such as based on manual review, genealogy data, and family tree data. Each training sample may include a selected haplotype dataset of a reference individual and a label identifying whether the reference individual belongs to a community.

The training samples of a community may also be generated by constructing a reference panel. FIG. 5B is a conceptual diagram graphically illustrating the construction of reference panel of a community in a geographical region using individuals who are uniquely assigned to the community. Construction of a reference panel of a community may start with a geographical region that includes a hierarchy of communities, which is illustrated in FIG. 5B (e.g., region A). Individual communities in the hierarchy may be communities A.1, A.2, A.3, A.1.1, A.1.2, etc. The hierarchy may be represented as a tree of communities, as shown in FIG. 5B. A target community can be any node, such as a leaf node in the hierarchy. For example, in FIG. 5B, the community A. 1.2 is the target community. The reference panel of the target community A.1.2 may be or comprise individuals who are uniquely assigned to the target community A.1.2. For example, a set operation may be performed to identify the reference panel of A.1.2. The reference panel of A.1.2 would be the set of {A.1.2.-{A.1.1 U A.2 U A.3}}, which is the set of A.1.2. minus the union of the sets of A.1.1, A.2, and A.3. Reference panels corresponding specifically to A and A.1 may be omitted entirely to avoid confounding the constructions of the reference panel for A.1.2. An analogous approach may be utilized for constructing the reference panels for other communities in the hierarchy. Other reference panels for other communities may be similarly constructed based on the uniquely assigned individuals. In some embodiments, individuals in the reference panel of a first community are the positive training samples of the first community and individuals in the reference panels of other communities are the negative training samples of the first community.

In some embodiments, the computing server 130 may create 420 labels for the training samples using reference panels associated with various communities. The reference panels for a community include individuals whose genetic data are representative of the community. In one example, the computing server 130 may create labels using bootstrapping stability experiments to create reference panels, e.g., positive examples. The computing server 130 may select negative examples using ethnicity-related criteria. For example, the criteria may be reverse criteria from the one for a positive set selection, e.g., initial community detection set.

In some embodiments, the trained model may be a supervised model. For example, each training sample may have a binary label indicating whether or not the training sample belongs to the community. If an individual is known to belong to a community, the training sample associated with the individual is labeled with a “1” (or labeled as positive), for example. Similarly, if an individual is known to not belong to the community, the training sample associated with the individual is labeled with a “0” (or labeled as negative), for example. In some embodiments, the computing server 130 may select a uniquely common haplotype within a community (e.g., enriched haplotypes) in the reference panel for training. The enriched haplotypes need not represent the haplotypes of a single individual. In some embodiments, the enriched haplotype may be the reference haplotype of the community.

Rather, the enriched haplotypes may represent a set of haplotypes that are most representative of the community, e.g., mostly likely to be observed in the community. This set of haplotypes may be used as features in a model and/or classifier. In this case, individuals with the enriched haplotypes may be labeled as positive and individuals without the enriched haplotypes may be labeled as negative.

In embodiments, the computing server 130 may identify commonly shared SNPs of a plurality of reference-panel individuals, with, in embodiments, an index of the commonly shared SNPs generated for the reference panel. During inference, a new dataset (e.g., a diploid or haploid dataset corresponding to a new user) may be compared against the index of commonly shared SNPs to determine affinity for a particular community, with appropriate thresholds for positively identifying the new dataset with the community predetermined. In other embodiments, the computing server 130 may assess a total shared cM of the haplotypes of the new dataset against the reference panels.

In some embodiments, the computing server 130 may add additional negative labels (e.g., 25% of the training samples) from null examples, e.g., examples that are not associated with the hierarchy of communities, such as ethnicity-based negatives. For example, when selecting training samples for a hierarchy of French American communities, samples that are not associated with French ethnicity assignment predictions (and therefore are likely not affiliated with the communities of the instant hierarchy) may be identified as null examples. In some embodiments, the computing server 130 may assign more weight to positively labeled training samples compared to negatively labeled examples due to the relatively smaller amount of positively labeled training samples. For example, a positively labeled training sample may be weighted five times more than a negatively labeled training sample.

The computing server 130 may create 430 a training set and a testing set using the training samples. The training set may be used to train the model for each community and the testing test may be used to evaluate the model performance. In some embodiments, the computing server 130 may generate the training and testing sets based on the labels of the training samples. For example, the computing server 130 may split the positively labeled and negatively labeled training samples into balanced training and testing sets. Positive training sets comprise groups of haplotypes of individuals known or determined to belong to a community. Negative training sets comprise groups of haplotypes of individuals known or determined to not belong to a community. In some implementations, the positive and negative training sets may be created based on the bootstrapping experiments and underlying ethnicity criteria for selection. The computing server 130 may apply an unsupervised learning model (e.g., a community detection model) to label the datasets and update the training sets with updated data and training.

The computing server 130 may generate 440 a feature vector for each training sample in the training and testing sets for a community. Selection of features, whether for the training sets, testing sets, or the actual individual samples, is further discussed below in FIGS. 5A, 5C, and 5D.

By way of example, FIG. 5A illustrates an example approach for processing haplotype data before features are selected, in accordance with some embodiments. For a given individual, whether the individual is a target user or an individual used for training, the computing server 130 compares the individual's haplotypes with the reference panel of each community. As shown in FIG. 5A as an example, each of the pair of an individual's haplotypes associated with the parents (P1 and P2) is compared with the reference panels of Community A, Community B, and Community C, respectively. The computing server 130 may determine the number of matches that the individual's haplotypes have with reference-panel individuals of Community A, B, and C. The matches may be IBD matches that are determined by the IBD estimation engine 225. The strength or category of the matches may be associated with the cumulative length of the IBD matches. The centimorgans (cM) between two individuals may determine the length or range of relatedness between the two individuals. The relatedness of two individuals based on the extent of matching in cM may be divided into buckets. Each bucket may be or comprise a cM range (e.g., 10 cM-20 cM, 20 cM-30 cM, etc.). The buckets may be referred to as a close match (e.g., immediate family or a first cousin), a second-cousin match, third-cousin match, fourth-cousin match, etc. For example, in FIG. 5A, the individual's haplotype from one parent (P1) has one close match to reference-panel individuals in Community A. This means that one individual in the reference panel of Community A is an IBD match and the extent of matching (in cM) falls within the range of the bucket that is considered as a close match. Using the same approach, the individual's other haplotype from the other parent (P2) is determined to have three close matches to reference-panel individuals in Community A. The individual's haplotype from one parent (P1) has two close matches to Community B and the individual's haplotype from the other parent (P2) has one close match to Community B.

In some embodiments, referring back to step 410, for each named entity whose data is potentially suitable to be used as training samples, for each community, the computing server 130 may select one of the named entity's haplotypes as a training sample for each community. As discussed above, for each of the individual's haplotypes, one of the haplotypes is inherited from one parent (P1) and the other of the haplotypes is inherited from the other parent (P2). In selecting the training samples, the computing server 130 may compare which haplotypes (e.g., from P1 or P2) has more matches within a certain community, and select the haplotype with more matches as the training data based on the comparison. For example, the computing server 130 may only select only the haplotype with a higher match (e.g. based on an assigned bucket, a number of IBD matches, cumulative cM shared with reference-panel individuals, etc.) with a community as the training data. As shown in FIG. 5A, the individual's haplotypes from both parents (P1 and P2) are compared to the reference panel of each community. For Community A, the haplotype from P2 has a higher match compared with the haplotype from P1 (e.g. the haplotype inherited from P2 has more close matches with reference-panel individuals of Community A than does the haplotype inherited from P1), and the computing server 130 may select the haplotype from P2 as a training sample for Community A. For Community B, the haplotype from P1 has a higher match compared with the haplotype from P2, and the computing server 130 may select the haplotype from P1 as the training sample for Community B. For Community C, as neither haplotype from P1 nor P2 has a close match, second-cousin match, or third-cousin match, the computing server 130 may determine not to use the data of this particular individual as training sample for Community C.

In embodiments, the “less influential” parental haplotype for a community, e.g. the P2 haplotype for Community B in FIG. 5A, may be compared against suitable statistics for the less-influential parental haplotypes across a plurality of communities, e.g. all identified communities. Where it has been determined by the computing server 130 that one parental haplotype for a particular community is less influential than the other parental haplotype given the other parental haplotype's strong connection to the community, but where the less influential parental haplotype is nonetheless more influential than the average “more-influential” parental haplotype of a plurality of, or even the rest of, the communities, the less influential parental haplotype for that community may be retained as a training sample. This is particularly advantageous in the case of small communities without a large corpus of positively labeled training samples, thereby improving the performance of the trained model for that particular community. This approach allows for a nuanced approach that considers the context of the community vis-à-vis the rest of the communities; for instance, in the example of Community B in FIG. 5A, it will be appreciated that while the P2 parental haplotype is clearly less influential than the P1 parental haplotype given the larger numbers of matches across categories, it is nevertheless much more strongly connected to Community B than, e.g., the P2 parental haplotype to Community A, which is the more influential parental haplotype for Community A. Facilitating a cross-community comparison therefore maximizes a potential number of positively labeled parental haplotypes for community-specific reference panel generation and, in turn, model training.

The construction of the table illustrated in FIG. 5A by comparing the haplotypes of an individual to a plurality of reference panels of different communities may also be used as part of the feature extraction process. The numbers of matches for each bucket may be a feature. In some embodiments, all of those numbers may be directly used as a feature vector of a haplotype. For example, the feature vector for the haplotype from P1 in FIG. 5A may take the form of [1, 0, 0, 0, 2, 2, 3, 8, 10, 10, 0, 0, 0, 2, 1]. In other embodiments, instead of using all of the features, the computing server 130 may select a certain number of features for each community for training the model. To select features, the computing server 130 may use a binary search method, for example, using logistic regression with L1 regularization and selecting non-zero features. In some embodiments, the number of non-zero features (N) may depend on a parameter (λ) of the binary search method. By tuning the number of non-zero features and the parameter, the computing server 130 may determine the non-zero features selected for training. Further detail on the feature selection is described in FIGS. 5C and 5D.

Referring back to FIG. 4A, the computing server 130 trains 450 the model using the training samples. In some embodiments, the computing server 130 may generate a data frame that includes the training sample. Each training sample in the data frame may include the feature vector corresponding to a particular individual and the respective label indicating whether or not the individual belongs to a community. The computing server 130 applies the model to the generated data frame and measures the performance of the model. The training process may include determining the classification results using the training samples and adjusting the parameters of the model to reduce or minimize the errors of the model based on the training labels. In some embodiments, the training process may include applying a plurality of XGBoost classifiers to the training sets to address underfitting.

In some embodiments, the training process may include bagging (e.g., bootstrap aggregation) to address the overfitting issue. Bagging is an ensemble learning method that is used to reduce variance within a noisy dataset. In bagging, a random sample of data in a training set is selected with replacement. The random sample may be used multiple times in the training process. In one instance, after selecting and using the random sample for training, the random sample may be returned to the training set and selected again for future trainings. For example, the training process may randomly sample 50% of the training set and apply an XGBoost classifier to the randomly sampled portion of the training set independently based on the labeled training samples. In some embodiments, this process may iterate multiple times. In each instance of bagging, the classifier may output a probability of a community assignment for a particular training sample. The probability of a community assignment indicates a likelihood of the individual belonging to the community. The computing server 130 may take an average or other suitable measure of the outputs from the plurality of bagging processes, and determine the average or other suitable measure as the prediction for a given individual, i.e., the prediction of community that the individual belongs to. The computing server 130 may determine 460 one or more thresholds for outputting a prediction of a community assignment.

It has been surprisingly found that the combination of Bagging and XGBoost addresses both the risks of overfitting to data and underfitting to data; that is, XGBoost and other suitable approaches advantageously minimize underfitting to the training data, while applying a Bagging and/or other suitable approach advantageously minimizes overfitting to training data.

FIG. 4B is a conceptual diagram illustrating various stages in an example process for training a haploid community assignment ML model, in accordance with some embodiments. The stages in FIG. 4B may be examples corresponding to various steps discussed in FIG. 4A. FIG. 4B and the following discussion provides further detail in training of a community classifier model. The numbers and specific techniques used are examples only and may not be adopted in every embodiment.

In FIG. 4B, the computing server 130 may create labels at stage 471 using feature vectors (“FV”), reference panels (“RP”), and null identifiers (“Null IDs”) to generate labeled data. By way of example, in some embodiments, the creation of labels at stage 471 may include creating labels using reference panels. FIG. 5B is a conceptual diagram graphically illustrating this stage. Referring to FIG. 5B, and as discussed above, if an individual is known to belong to a community, the computing server 130 may label the training sample associated with the individual with “1”. Similarly, if an individual is known to not belong to the community, the training sample associated with the individual is labeled with a “0”. In some embodiments, individuals with the enriched haplotypes may be labeled as positive and individuals without the enriched haplotypes may be labeled as negative. In some embodiments, the computing server 130 may add additional negative labels (e.g., 25%) from null examples (e.g., Null IDs). As discussed above, null examples may include ethnicity-based negatives, including those individuals who, based on ethnicity assignment predictions generated by, e.g., the Ethnicity Estimation Engine 245, are determined to be categorically unrelated to the particular hierarchy. Thus in a hierarchy pertaining to French American communities, an individual with an ethnicity assignment prediction that suggests little or no French ethnicity would be considered a null example, as anyone in a French American community would be assumed to have some meaningful amount of French ethnicity assignment. In another implementation, the computing server 130 may assign more weight (e.g., five times) to positively labeled training samples compared to negatively labeled examples due to the smaller amount of positively labeled training samples. The labels generated at stage 471 may be applied to or associated with the training samples to yield Labeled Data.

Referring back to FIG. 4B, from the labeled data, at stage 472, the computing server 130 may create training sets and testing sets by splitting the labeled data into two sets and assigning corresponding labels (e.g. Train IDs vs. Test IDs) to each set. In some embodiments, the computing server 130 may split the positively labeled and negatively labeled training samples into balanced training and testing sets given the labels based on a predetermined ratio. The ratio may be one to one or another appropriate balance.

At stage 473, the computing server 130 may select features for training the haploid community assignment ML classifier model. The haplotype is first compared to reference panels of various communities, as discussed above in FIG. 5A. FIG. 5C is a conceptual diagram graphically illustrating the feature-selection process. Referring to FIG. 5C, the computing server 130 may select a certain number and combination of features for each community for training the model. As discussed regarding FIG. 5A, the features may be a number of matches in a particular relationship category detected between a particular haplotype dataset, such as a parental haplotype, and reference-panel individuals of a particular community. With an exemplary five buckets per community (corresponding, e.g., to close, second-cousin, third-cousin, fourth-cousin, and distant relationships), this may result in a full unfiltered feature vector comprising five features per community per haplotype dataset. The computing server 130 may collect the feature vectors with unfiltered features of various training samples along with the labels of the training samples. In turn, the computing server 130 may select non-zero features and use logistic regression with L1 regularization (Lease Absolute Shrinkage and Selection Operation “Lasso” regression) for selecting the features.

Additionally, or alternatively, in selecting features, the computing server may apply a binary search to select the non-zero features. FIG. 5D is a conceptual diagram graphically illustrating the binary search process. As shown in FIG. 5D, the computing server 130 may apply an objective function, which may be presented as follows:

$${}_{w}^{ArgMin} J = error ( X , y , w ) + λ \qquad ( 1 )$$

Here, the number of non-zero features, N(λ), represents the number of non-zero weights for a given λ, which may depend on a parameter (λ) of the binary search method. Nₘᵢₙ and Nₘₐₓ may provide an acceptable range for N(λ). In order to find the range of (λₘᵢₙ, λₘₐₓ), the computing server 130 may define λ_{mid}=mean (λₘᵢₙ+λₘₐₓ) and y=N(λ_{mid}). The computing server 130 may adjust the value of A and obtain the corresponding values of y. In one example, if y<Nₘᵢₙ, then the computing server 130 may find a range of (λ_{mid}, λₘₐₓ); if y>Nₘₐₓ, then the computing server 130 may find a range of (λₘᵢₙ, λ_{mid}), and the computing server 130 may determine the value of λ_{mid} correspondingly. In this way, by tuning the number of non-zero features and the parameter (λ), the computing server 130 may determine the non-zero features selected for training.

At stage 474, the computing server 130 may train classifiers using the labeled data, selected features, and training IDs. FIG. 5E is a conceptual diagram graphically illustrating this stage. Referring to FIG. 5E, the computing server 130 may use bagging and train a plurality of XGBoost classifiers, as described above regarding the step 450 of FIG. 4A. For example, the computing server 130 may randomly sample, e.g., 50% of the training set and apply, e.g., an XGBoost classifier to the sampled training set independently based on the randomly sampled, labeled training samples. In some embodiments, this process may iterate multiple times, such as 20 times. In each instance of bagging, the classifier may output a probability of a community assignment for the corresponding training sample. The computing server 130 may take an average of the outputs of the bagging processes, and determine the average as the prediction for a given individual, i.e., the prediction of community that the individual belongs to. As seen in FIG. 5E, the average of the predictions for the classifiers trained for each instance of bagging may be 0.35, in other words a 35% likelihood that an individual belongs to a community. The use of Bagging in combination with XGBoost advantageously addresses the risks of both underfitting and overfitting. It will be appreciated that while XGBoost is described, the disclosure is not limited thereto, but rather any suitable modality for classifying datasets may be utilized.

Referring back to FIG. 4B, at stage 475, the computing server 130 may determine one or more thresholds for outputting a prediction of a community assignment. FIG. 5F is a conceptual diagram graphically illustrating this stage. Referring to FIG. 5F, the computing server 130 may determine one or more thresholds for the output of the classifiers. In some embodiments, an individual is classified as belonging to a given community if the probability computed by the trained model exceeds a threshold numerical value. In one example, a probability threshold may be selected based on the parameters in the training process. A threshold may be determined as achieving a recall of 0.5 or more, a precision of 0.2 or more, a maximum f-score, with beta=3, and the like. The threshold for classifying individuals to communities may be the same or different for each model.

The computing server 130 may assign a level of confidence to the outcome from the model, such as low, medium, and high. In some embodiments, the probability threshold may be used to determine the confidence level of the community assignment. Based on the outcomes and the level of confidence, the output from the model may indicate whether the individual is a member of the community. In one example, a low confidence score may be associated with a probability threshold where a maximum f-score with beta is equal to 3; a median confidence score may be associated with a probability threshold where a maximum f-score with beta is equal to 1; and a high confidence score may be associated with a probability threshold where a maximum f-score with beta is equal to 0.25.

The systems, methods, computer-program products, and approaches of the disclosed embodiments advantageously result in a novel and improved approach for detecting an inheritance of a portion of a dataset, such as a parental inheritance of a genetic community affiliation. This can advantageously be performed agnostic to any information received from the parents themselves; rather, an individual provides their own diploid genetic dataset, and the computing server 130 is configured to utilize one or more of the tools and techniques described herein to both generate community-specific models based on a plurality of datasets, such as genetic datasets, and also to perform inference to assign a new dataset, such as a genetic dataset from a new customer, to one or more communities using the trained community-specific models, on the basis of the new dataset.

To generate community-specific models, the computing server 130 may generate reference panels comprising datasets determined on the basis of matching to be associated with a community; generate labeled data from feature vectors associated with the reference-panel datasets that have been determined on the basis of matching to be associated with a community; create training and test sets of labeled data; perform feature selection to identify the most-pertinent features; train a community-specific classifier using the selected features from the feature vectors of the labeled data of the training and test sets; and select confidence thresholds.

The aforementioned series of operations may be performed in substantially a same or analogous way for and using both unphased datasets, e.g. unphased diploid genetic datasets, and phased datasets, e.g. phased haploid genetic datasets. That is, community-specific classifiers may be built for and using unphased datasets; and optionally community-specific classifiers may be built for and using phased datasets. In embodiments, the features that are selected for unphased datasets are selected in phased datasets; in other embodiments, the feature-selection process is performed independently for phased datasets in order to identify an optimized set of features for phased datasets. For example, during feature selection, the number of features for a community-detection model may be reduced from, e.g., 500 to approximately 40, resulting in substantial processing-cost savings. For example, it has been surprisingly found that a 25× reduction in memory can be achieved by performing feature selection according to the disclosed embodiments, as the features corresponding to hundreds of reference panel-matches in hundreds of communities can be reduced to yield a 25× lower-memory and -cost implementation.

To perform community-assignment or inference for a new dataset, a feature vector may be generated based on an unphased dataset, e.g. a diploid genetic dataset, for an individual; the dataset may be phased using a phasing modality through, e.g., the phasing engine 220; and/or a same or different feature vector may be generated based on the phased dataset, e.g. a phased haploid genetic dataset, for the individual; and the feature vector and/or the unphased and/or phased datasets for the individual may be passed as input to a plurality of trained community-specific classifiers to generate an assignment prediction for the individual. Where the assignment predictions exceed respective confidence thresholds, the user may be assigned to the community by the computing server 130. In embodiments, the computing server 130 performs community detection first on a user's unphased genetic data, then performs community detection on the user's phased genetic data.

In embodiments, the user is assigned to communities on the basis of the unphased genetic data results, and then certain of the assigned communities are determined to be attributable to one, both, or neither of the user's parents based on the phased genetic data results. For example, the user may be assigned to five total communities: A, B, C, D, and E (on the basis of their unphased data and the corresponding unphased community-assignment classifier models returning high-confidence scores therefor), and, using their phased data, a high-confidence score is attributed to a particular one of the user's haplotypes (corresponding to one of the user's parents) on the corresponding classifier models for communities A, B, and C. A high-confidence score is attributed to the other one of the user's haplotypes (corresponding to the other one of the user's parents) on the classifier models for communities C and D. Neither haplotype returns a high-confidence score for community E. The user's results may indicate their association with communities A, B, C, D, and E, and may indicate that their haplotype associated with “parent one” is associated with communities A and B, their haplotype associated with “parent two” is associated with community D, both haplotypes and therefore both parents are associated with community C, and community E is indeterminate as to parental haplotype.

It has been surprisingly found that the disclosed embodiments advantageously facilitate the prediction and assignment of communities associated with a user to one or both of the user's parents without information about or from the parents themselves. Indeed, in French American communities, it has been surprisingly found that using the disclosed approach results in 95% success rate in assigning communities for a user to a parent, with 85% of communities associated with a single parent, and 10% of communities associated with both parents. Users are thereby empowered to further their genealogical and genetic research by pursuing family side-specific research in particular communities.

Too, it has been surprisingly found that phasing has different qualities/reliability in different communities. The performance of the phasing engine 220 may vary based on a number of datasets associated with a particular ethnicity and/or community; in small communities, the results of phasing may be such that the communities identified for a user based on unphased datasets and corresponding models is greater than a sum of the communities identified for the user based on phased datasets and corresponding models. In such cases, it is possibly due to phasing-quality variance, and therefore an “unassigned” or “indeterminate” category is provided for the communities identified via unphased datasets that are not accounted for via phased datasets. In the example mentioned above regarding French American communities, the 5% of communities that are not assigned to a parent are in an “unassigned” category based on assignment via unphased datasets but not also in phased datasets.

### Example Machine Learning Models

In various embodiments, a wide variety of machine learning techniques may be used. Examples include different forms of supervised learning, unsupervised learning, and semi-supervised learning such as decision trees, support vector machines (SVMs), regression, Bayesian networks, and genetic algorithms. Deep learning techniques such as neural networks, including convolutional neural networks (CNN), recurrent neural networks (RNN) and long short-term memory networks (LSTM), may also be used. For example, various community assignment performed by the community assignment engine 230, and other processes may apply one or more machine learning and deep learning techniques.

In various embodiments, the training techniques for a machine learning model may be supervised, semi-supervised, or unsupervised. In supervised learning, the machine learning models may be trained with a set of training samples that are labeled. For example, for a machine learning model trained to assign community for an individual, the training samples may be associated with haplotype datasets. The training samples may be generated based on the genetic data. The labels for each training sample may be binary or multi-class. In training a machine learning model for assigning a community for an individual, the training labels may include a positive label that indicates that the individual belongs to a community and a negative label that indicates that the individual does not belong to a community. In some embodiments, the training labels may also be multi-class.

By way of example, the training set may include multiple past records of haplotypes with known outcomes. Each training sample in the training set may correspond to a past and the corresponding outcome may serve as the label for the sample. A training sample may be represented as a feature vector that include multiple dimensions. Each dimension may include data of a feature, which may be a quantized value of an attribute that describes the past record. For example, in a machine learning model that is used to assign a community for an individual, the features in a feature vector may include reference haplotypes (e.g., an enriched haplotype), and the value of each element indicates the present or absence of the reference haplotype in the individual associated with the training sample, and/or any features that are selected as discussed in FIGS. 5A, 5C, and 5D. In various embodiments, certain pre-processing techniques may be used to normalize the values in different dimensions of the feature vector.

In some embodiments, an unsupervised learning technique may be used. The training samples used for an unsupervised model may also be represented by features vectors, but may not be labeled. Various unsupervised learning techniques such as clustering may be used in determining similarities among the feature vectors, thereby categorizing the training samples into different clusters. In some cases, the training may be semi-supervised with a training set having a mix of labeled samples and unlabeled samples.

A machine learning model may be associated with an objective function, which generates a metric value that describes the objective goal of the training process. The training process may intend to reduce the error rate of the model in generating predictions. In such a case, the objective function may monitor the error rate of the machine learning model. In a model that generates predictions, the objective function of the machine learning algorithm may be the training error rate when the predictions are compared to the actual labels. Such an objective function may be called a loss function. Other forms of objective functions may also be used, particularly for unsupervised learning models whose error rates are not easily determined due to the lack of labels. In various embodiments, the error rate may be measured as cross-entropy loss, L1 loss (e.g., the sum of absolute differences between the predicted values and the actual value), L2 loss (e.g., the sum of squared distances).

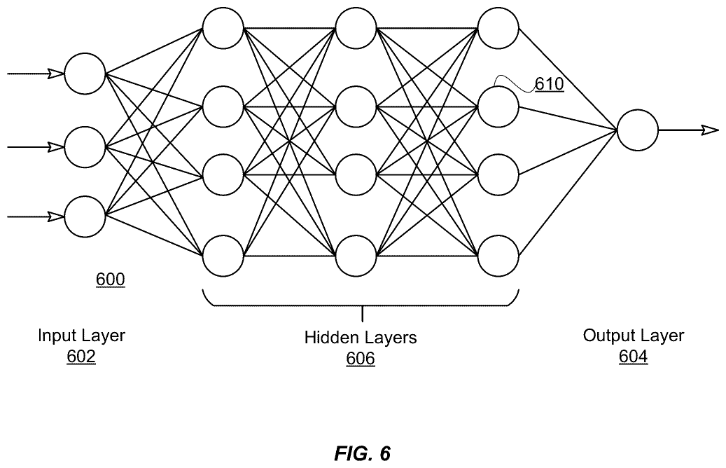

Referring to FIG. 6, a structure of an example neural network is illustrated, in accordance with some embodiments. The neural network 600 may receive an input and generate an output. The input may be the feature vector of a training sample in the training process and the feature vector of an actual case when the neural network is making an inference. The output may be the prediction, classification, or another determination performed by the neural network. The neural network 600 may include different kinds of layers, such as convolutional layers, pooling layers, recurrent layers, fully connected layers, and custom layers. A convolutional layer convolves the input of the layer (e.g., an image) with one or more kernels to generate different types of images that are filtered by the kernels to generate feature maps. Each convolution result may be associated with an activation function. A convolutional layer may be followed by a pooling layer that selects the maximum value (max pooling) or average value (average pooling) from the portion of the input covered by the kernel size. The pooling layer reduces the spatial size of the extracted features. In some embodiments, a pair of convolutional layer and pooling layer may be followed by a recurrent layer that includes one or more feedback loops. The feedback may be used to account for spatial relationships of the features in an image or temporal relationships of the objects in the image. The layers may be followed by multiple fully connected layers that have nodes connected to each other. The fully connected layers may be used for classification and object detection. In one embodiment, one or more custom layers may also be presented for the generation of a specific format of the output. For example, a custom layer may be used for image segmentation for labeling pixels of an image input with different segment labels.

The order of layers and the number of layers of the neural network 600 may vary in different embodiments. In various embodiments, a neural network 600 includes one or more layers 602, 604, and 606, but may or may not include any pooling layer or recurrent layer. If a pooling layer is present, not all convolutional layers are always followed by a pooling layer. A recurrent layer may also be positioned differently at other locations of the CNN. For each convolutional layer, the sizes of kernels (e.g., 3×3, 5×5, 7×7, etc.) and the numbers of kernels allowed to be learned may be different from other convolutional layers.

A machine learning model may include certain layers, nodes 610, kernels and/or coefficients. Training of a neural network, such as the NN 600, may include forward propagation and backpropagation. Each layer in a neural network may include one or more nodes, which may be fully or partially connected to other nodes in adjacent layers. In forward propagation, the neural network performs the computation in the forward direction based on the outputs of a preceding layer. The operation of a node may be defined by one or more functions. The functions that define the operation of a node may include various computation operations such as convolution of data with one or more kernels, pooling, recurrent loop in RNN, various gates in LSTM, etc. The functions may also include an activation function that adjusts the weight of the output of the node. Nodes in different layers may be associated with different functions.

Training of a machine learning model may include an iterative process that includes iterations of making determinations, monitoring the performance of the machine learning model using the objective function, and backpropagation to adjust the weights (e.g., weights, kernel values, coefficients) in various nodes 610. For example, a computing device may receive a training set that includes haplotypes of training samples. Each training sample in the training set may be assigned with labels indicating whether an associated individual belongs to a community. The computing device, in a forward propagation, may use the machine learning model to generate predicted community that the individual belongs to. The computing device may compare the predicted community assignment with the labels of the training sample. The computing device may adjust, in a backpropagation, the weights of the machine learning model based on the comparison. The computing device backpropagates one or more error terms obtained from one or more loss functions to update a set of parameters of the machine learning model. The backpropagating may be performed through the machine learning model and one or more of the error terms based on a difference between a label in the training sample and the generated predicted value by the machine learning model.

By way of example, each of the functions in the neural network may be associated with different coefficients (e.g., weights and kernel coefficients) that are adjustable during training. In addition, some of the nodes in a neural network may also be associated with an activation function that decides the weight of the output of the node in forward propagation. Common activation functions may include step functions, linear functions, sigmoid functions, hyperbolic tangent functions (tanh), and rectified linear unit functions (RcLU). After an input is provided into the neural network and passes through a neural network in the forward direction, the results may be compared to the training labels or other values in the training set to determine the neural network's performance. The process of prediction may be repeated for other samples in the training sets to compute the value of the objective function in a particular training round. In turn, the neural network performs backpropagation by using gradient descent such as stochastic gradient descent (SGD) to adjust the coefficients in various functions to improve the value of the objective function.

Multiple rounds of forward propagation and backpropagation may be performed. Training may be completed when the objective function has become sufficiently stable (e.g., the machine learning model has converged) or after a predetermined number of rounds for a particular set of training samples. The trained machine learning model can be used for performing community assignment or another suitable task for which the model is trained.

### Computing Machine Architecture

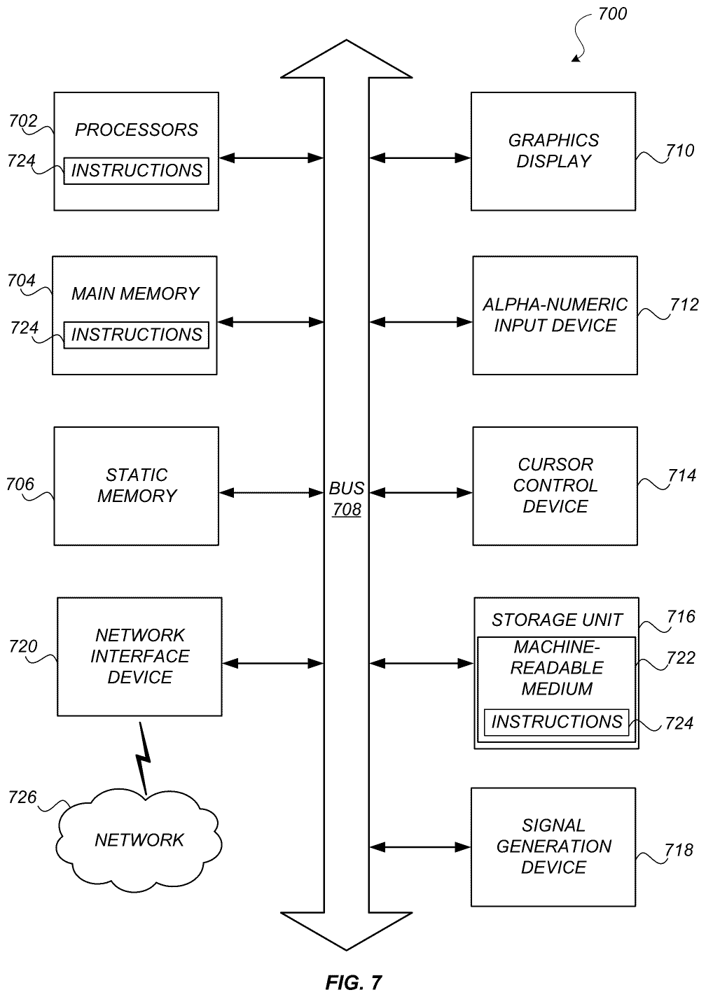

FIG. 7 is a block diagram illustrating components of an example computing machine that is capable of reading instructions from a computer-readable medium and execute them in a processor (or controller). A computer described herein may include a single computing machine shown in FIG. 7, a virtual machine, a distributed computing system that includes multiple nodes of computing machines shown in FIG. 7, or any other suitable arrangement of computing devices.

By way of example, FIG. 7 shows a diagrammatic representation of a computing machine in the example form of a computer system 700 within which instructions 724 (e.g., software, source code, program code, expanded code, object code, assembly code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 7 may correspond to any software, hardware, or combined components shown in FIGS. 1 and 2, including but not limited to, the client device 110, the computing server 130, and various engines, interfaces, terminals, and machines shown in FIG. 2. While FIG. 7 shows various hardware and software elements, each of the components described in FIGS. 1 and 2 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 724 that specify actions to be taken by that machine. Further, while only a single machine is illustrated, the term “machine” and “computer” may also be taken to include any collection of machines that individually or jointly execute instructions 724 to perform any one or more of the methodologies discussed herein.

The example computer system 700 includes one or more processors 702 such as a CPU (central processing unit), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 700 may also include a memory 704 that store computer code including instructions 724 that may cause the processors 702 to perform certain actions when the instructions are executed, directly or indirectly by the processors 702. Instructions can be any directions, commands, or orders that may be stored in different forms, such as equipment-readable instructions, programming instructions including source code, and other communication signals and orders. Instructions may be used in a general sense and are not limited to machine-readable codes. One or more steps in various processes described may be performed by passing through instructions to one or more multiply-accumulate (MAC) units of the processors.

One and more methods described herein improve the operation speed of the processors 702 and reduces the space required for the memory 704. For example, the database processing techniques and machine learning methods described herein reduce the complexity of the computation of the processors 702 by applying one or more novel techniques that simplify the steps in training, reaching convergence, and generating results of the processors 702. The algorithms described herein also reduces the size of the models and datasets to reduce the storage space requirement for memory 704.

The performance of certain operations may be distributed among more than one processor, not only residing within a single machine, but deployed across a number of machines. In some example embodiments, the one or more processors or processor-implemented modules may be located in a single geographic location (e.g., within a home environment, an office environment, or a server farm). In other example embodiments, one or more processors or processor-implemented modules may be distributed across a number of geographic locations. Even though in the specification or the claims may refer some processes to be performed by a processor, this should be construed to include a joint operation of multiple distributed processors.

The computer system 700 may include a main memory 704, and a static memory 706, which are configured to communicate with each other via a bus 708. The computer system 700 may further include a graphics display unit 710 (e.g., a plasma display panel (PDP), a liquid crystal display (LCD), a projector, or a cathode ray tube (CRT)). The graphics display unit 710, controlled by the processors 702, displays a graphical user interface (GUI) to display one or more results and data generated by the processes described herein. The computer system 700 may also include alphanumeric input device 712 (e.g., a keyboard), a cursor control device 714 (e.g., a mouse, a trackball, a joystick, a motion sensor, or other pointing instruments), a storage unit 716 (a hard drive, a solid-state drive, a hybrid drive, a memory disk, etc.), a signal generation device 718 (e.g., a speaker), and a network interface device 720, which also are configured to communicate via the bus 708.

The storage unit 716 includes a computer-readable medium 722 on which is stored instructions 724 embodying any one or more of the methodologies or functions described herein. The instructions 724 may also reside, completely or at least partially, within the main memory 704 or within the processor 702 (e.g., within a processor's cache memory) during execution thereof by the computer system 700, the main memory 704 and the processor 702 also constituting computer-readable media. The instructions 724 may be transmitted or received over a network 726 via the network interface device 720.

While computer-readable medium 722 is shown in an example embodiment to be a single medium, the term “computer-readable medium” should be taken to include a single medium or multiple media (e.g., a centralized or distributed database, or associated caches and servers) able to store instructions (e.g., instructions 724). The computer-readable medium may include any medium that is capable of storing instructions (e.g., instructions 724) for execution by the processors (e.g., processors 702) and that cause the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

### Additional Embodiments

Clause 1. A computer-implemented method, comprising: obtaining user data from an individual; phasing the user data to generate a pair of datasets of the individual; selecting features one of the datasets of the pair of datasets of the individual; inputting the selected features into a trained model, wherein training the model comprises: obtaining a plurality of training samples, each training sample comprising features of a reference individual and a label identifying whether the reference individual belongs to a community, wherein reference individuals who belong to the community are representatives of the community, and applying the model to the plurality of training samples; receiving an output from the model, the output providing information associated with a community assignment of the individual.

Clause 2. The method of clause 1, wherein applying a plurality of classifiers to at least one of the training samples to obtain an output from each classifier comprises: for at least one of the plurality of classifiers, randomly selecting at least one of the training samples using Bagging; and applying the at least one of the plurality of classifiers to the selected at least one training sample to obtain an output from the at least one of the plurality of classifiers.

Clause 3. The method of clause 1, wherein at least one of the plurality of classifiers is XGBoost.

Clause 4. The method of clause 1, wherein obtaining a plurality of training samples comprises: receiving target user data from a target individual, wherein the target individual is associated with a first label identifying whether the target individual belongs to a first community; phasing the target user data of the target individual to generate a pair of target datasets of the target individual; comparing each of the target datasets of the target individual to a dataset of a reference individual who belongs to the first community; determining a number of matches with the dataset of the reference individual between each of the target datasets of the target individual; and determining the target dataset having a higher number of matches as the selected dataset of phased user data of the target individual in a training sample.

Clause 5. The method of clause 1, wherein the output from the model includes a prediction that the individual belongs to a community and a confidence level of the community assignment.

Clause 6. The method of clause 1, wherein training the model further comprises: selecting a uniquely common dataset as the selected dataset of the phased user data that is representative of the community, wherein the uniquely common dataset is most likely to be observed in the community.

Clause 7. The method of clause 6, wherein training the model further comprises: generating a feature vector for at least one of the training samples for the community based on the selected dataset of the phased user data, the feature vector comprising one or more non-zero feature elements.

Clause 8. A computer-readable storage medium having stored thereon computer-executable instructions that, when executed by one or more processors, cause the one or more processors to perform operations, comprising: obtaining user data from an individual; phasing the user data to generate a pair of datasets of the individual; selecting features of each dataset of the individual; inputting the selected features into a trained model, wherein training the model comprises: obtaining a plurality of training samples, each training sample comprising a selected dataset of phased user data of a reference individual and a label identifying whether the reference individual belongs to a community, wherein reference individuals who belong to the community are representative of the community, and applying the model to the plurality of training samples; and receiving an output from the model, the output providing information associated with a community assignment of the individual.

Clause 9. The computer-readable storage medium of clause 8, wherein applying a plurality of classifiers to at least one of the training samples to obtain an output from each classifier comprises: for at least one of the plurality of classifiers, randomly selecting at least one of the training samples using Bagging; and applying the at least one of the plurality of classifiers to the selected at least one training sample to obtain an output from the at least one of the plurality of classifiers.

Clause 10. The computer-readable storage medium of clause 8, wherein at least one of the plurality of classifiers is XGBoost.

Clause 11. The computer-readable storage medium of clause 8, wherein obtaining a plurality of training samples comprises: receiving target user data from a target individual, wherein the target individual is associated with a first label identifying whether the target individual belongs to a first community; phasing the target user data of the target individual to generate a pair of target datasets of the target individual; comparing each of the target datasets of the target individual to a dataset of a reference individual who belongs to the first community; determining a number of matches with the dataset of the reference individual between each of the target datasets of the target individual; and determining the target dataset having a higher number of matches as the selected dataset of phased user data of the target individual in a training sample.

Clause 12. The computer-readable storage medium of clause 8, wherein the output from the model includes a prediction that the individual belongs to a community and a confidence level of the community assignment.

Clause 13. The computer-readable storage medium of clause 8, wherein training the model further comprises: selecting a uniquely common dataset as the selected dataset of the phased user data that is representative of the community, wherein the uniquely common dataset is most likely to be observed in the community.

Clause 14. The computer-readable storage medium of clause 13, wherein training the model further comprises: generating a feature vector for at least one of the training samples for the community based on the selected dataset of the phased user data, the feature vector comprising one or more non-zero feature elements.

Clause 15. A computer system, comprising: one or more processors; and a hardware storage device having stored thereon computer-executable instructions that, when executed by the one or more processors, causes the computer system to perform operations, comprising: obtaining user data from an individual; phasing the user data to generate a pair of datasets of the individual; selecting features of each dataset of the individual; inputting the selected features into a trained model, wherein training the model comprises: obtaining a plurality of training samples, each training sample comprising a selected dataset of phased user data of a reference individual and a label identifying whether the reference individual belongs to a community, wherein reference individuals who belong to the community are representative of the community, and applying the model to the plurality of training samples; and receiving an output from the model, the output providing information associated with a community assignment of the individual.

Clause 16. The computer system of clause 15, wherein applying a plurality of classifiers to at least one of the training samples to obtain an output from each classifier comprises: for at least one of the plurality of classifiers, randomly selecting at least one of the training samples using Bagging; and applying the at least one of the plurality of classifiers to the selected at least one training sample to obtain an output from the at least one of the plurality of classifiers.

Clause 17. The computer system of clause 15, wherein at least one of the plurality of classifiers is XGBoost.

Clause 18. The computer system of clause 15, wherein obtaining a plurality of training samples comprises: receiving target user data from a target individual, wherein the target individual is associated with a first label identifying whether the target individual belongs to a first community; phasing the target user data of the target individual to generate a pair of target datasets of the target individual; comparing each of the target datasets of the target individual to a dataset of a reference individual who belongs to the first community; determining a number of matches with the dataset of the reference individual between each of the target datasets of the target individual; and determining the target dataset having a higher number of matches as the selected dataset of phased user data of the target individual in a training sample.

Clause 19. The computer system of clause 15, wherein the output from the model includes a prediction that the individual belongs to a community and a confidence level of the community assignment.

Clause 20. The computer system of clause 15, wherein training the model further comprises: selecting a uniquely common dataset as the selected dataset of the phased user data that is representative of the community, wherein the uniquely common dataset is most likely to be observed in the community.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g., method, can be claimed in another claim category, e.g. computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In some embodiments, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed in the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

The following applications are incorporated by reference in their entirety for all purposes: (1) U.S. Pat. No. 10,679,729, entitled “Haplotype Phasing Models,” granted on Jun. 9, 2020, (2) U.S. Pat. No. 10,223,498, entitled “Discovering Population Structure from Patterns of Identity-By-Descent,” granted on Mar. 5, 2019, (3) U.S. Pat. No. 10,720,229, entitled “Reducing Error in Predicted Genetic Relationships,” granted on Jul. 21, 2020, (4) U.S. Pat. No. 10,558,930, entitled “Local Genetic Ethnicity Determination System,” granted on Feb. 11, 2020, (5) U.S. Pat. No. 10,114,922, entitled “Identifying Ancestral Relationships Using a Continuous Stream of Input,” granted on Oct. 30, 2018, (6) U.S. Pat. No. 11,429,615, entitled “Linking Individual Datasets to a Database,” granted on Aug. 30, 2022, (7) U.S. Pat. No. 10,692,587, entitled “Global Ancestry Determination System,” granted on Jun. 23, 2020, and (8) U.S. Patent Application Publication No. US 2021/0034647, entitled “Clustering of Matched Segments to Determine Linkage of Dataset in a Database,” published on Feb. 4, 2021.

What is claimed is:

1. A computer-implemented method, comprising:
phasing user data associated with a named entity to generate a pair of datasets of the named entity;
selecting features of one of the datasets of the pair of datasets of the named entity;
inputting the selected features into a trained model, wherein the model has been trained by:
obtaining a plurality of training samples, each training sample comprising features of a reference named entity and a label identifying whether the reference named entity belongs to a community, wherein reference named entities who belong to the community are representatives of the community, and
applying the model to the plurality of training samples;
receiving an output from the model, the output providing information associated with a community assignment of the named entity.

2. The method of claim 1, wherein applying the model to the plurality of training samples comprises:
applying a plurality of classifiers to at least one of the training samples to obtain an output from each classifier, comprising:
for at least one of the plurality of classifiers,
randomly selecting at least one of the training samples using Bagging; and
applying the at least one of the plurality of classifiers to the selected at least one training sample to obtain an output from the at least one of the plurality of classifiers.

3. The method of claim 2, wherein at least one of the plurality of classifiers is XGBoost.

4. The method of claim 1, wherein obtaining a plurality of training samples comprises:
receiving target user data from a target named entity, wherein the target named entity is associated with a first label identifying whether the target named entity belongs to a first community;
phasing the target user data of the target named entity to generate a pair of target datasets of the target named entity;
comparing each of the target datasets of the target named entity to a dataset of a reference named entity who belongs to the first community;
determining a number of matches with the dataset of the reference named entity between each of the target datasets of the target named entity; and
determining the target dataset having a higher number of matches as the selected dataset of phased user data of the target named entity in a training sample.

5. The method of claim 1, wherein the output from the model includes a prediction that the named entity belongs to a community and a confidence level of the community assignment.

6. The method of claim 1, wherein training the model further comprises:
selecting a uniquely common dataset as the selected dataset of the phased user data that is representative of the community, wherein the uniquely common dataset is most likely to be observed in the community.

7. The method of claim 6, wherein training the model further comprises:
generating a feature vector for at least one of the training samples for the community based on the selected dataset of the phased user data, the feature vector comprising one or more non-zero feature elements.

8. A computer-readable storage medium having stored thereon computer-executable instructions that, when executed by one or more processors, cause the one or more processors to perform operations, comprising:
phasing user data associated with a named entity to generate a pair of datasets of the named entity;
selecting features of one of the datasets of the pair of datasets of the named entity;
inputting the selected features into a trained model, wherein the model has been trained by:
obtaining a plurality of training samples, each training sample comprising a selected dataset of phased user data of a reference named entity and a label identifying whether the reference named entity belongs to a community, wherein reference named entities who belong to the community are representative of the community, and
applying the model to the plurality of training samples; and
receiving an output from the model, the output providing information associated with a community assignment of the named entity.

9. The computer-readable storage medium of claim 8, wherein applying the model to the plurality of training samples comprises:
applying a plurality of classifiers to at least one of the training samples to obtain an output from each classifier, comprising:
for at least one of the plurality of classifiers,
randomly selecting at least one of the training samples using Bagging; and
applying the at least one of the plurality of classifiers to the selected at least one training sample to obtain an output from the at least one of the plurality of classifiers.

10. The computer-readable storage medium of claim 9, wherein at least one of the plurality of classifiers is XGBoost.

11. The computer-readable storage medium of claim 8, wherein obtaining a plurality of training samples comprises:
receiving target user data from a target named entity, wherein the target named entity is associated with a first label identifying whether the target named entity belongs to a first community;
phasing the target user data of the target named entity to generate a pair of target datasets of the target named entity;
comparing each of the target datasets of the target named entity to a dataset of a reference named entity who belongs to the first community;
determining a number of matches with the dataset of the reference named entity between each of the target datasets of the target named entity; and
determining the target dataset having a higher number of matches as the selected dataset of phased user data of the target named entity in a training sample.

12. The computer-readable storage medium of claim 8, wherein the output from the model includes a prediction that the named entity belongs to a community and a confidence level of the community assignment.

13. The computer-readable storage medium of claim 8, wherein training the model further comprises:
selecting a uniquely common dataset as the selected dataset of the phased user data that is representative of the community, wherein the uniquely common dataset is most likely to be observed in the community.

14. The computer-readable storage medium of claim 13, wherein training the model further comprises:
generating a feature vector for at least one of the training samples for the community based on the selected dataset of the phased user data, the feature vector comprising one or more non-zero feature elements.

15. A computer system, comprising:
one or more processors; and
a hardware storage device having stored thereon computer-executable instructions that, when executed by the one or more processors, causes the computer system to perform operations, comprising:
phasing user data associated with a named entity to generate a pair of datasets of the named entity;
selecting features of one of the datasets of the pair of datasets of the named entity;
inputting the selected features into a trained model, wherein the model has been trained by:
obtaining a plurality of training samples, each training sample comprising a selected dataset of phased user data of a reference named entity and a label identifying whether the reference named entity belongs to a community, wherein reference named entities who belong to the community are representative of the community, and
applying the model to the plurality of training samples; and
receiving an output from the model, the output providing information associated with a community assignment of the named entity.

16. The computer system of claim 15, wherein applying the model to the plurality of training samples comprises:
applying a plurality of classifiers to at least one of the training samples to obtain an output from each classifier, comprising:
for at least one of the plurality of classifiers,
randomly selecting at least one of the training samples using Bagging; and
applying the at least one of the plurality of classifiers to the selected at least one training sample to obtain an output from the at least one of the plurality of classifiers.

17. The computer system of claim 16, wherein at least one of the plurality of classifiers is XGBoost.

18. The computer system of claim 15, wherein obtaining a plurality of training samples comprises:
receiving target user data from a target named entity, wherein the target named entity is associated with a first label identifying whether the target named entity belongs to a first community;
phasing the target user data of the target named entity to generate a pair of target datasets of the target named entity;
comparing each of the target datasets of the target named entity to a dataset of a reference named entity who belongs to the first community;
determining a number of matches with the dataset of the reference named entity between each of the target datasets of the target named entity; and
determining the target dataset having a higher number of matches as the selected dataset of phased user data of the target named entity in a training sample.

19. The computer system of claim 15, wherein the output from the model includes a prediction that the named entity belongs to a community and a confidence level of the community assignment.

20. The computer system of claim 15, wherein training the model further comprises:
selecting a uniquely common dataset as the selected dataset of the phased user data that is representative of the community, wherein the uniquely common dataset is most likely to be observed in the community.
